(19) United States
(12) Patent Application Publication
(10) Pub. No.: US 2008/0143734 A1
(43) Pub. Date: Jun. 19, 2008

(54) Image-displaying system, image-displaying apparatus, and image-displaying method

(76) Inventors: Kensuke Ishii, Tokyo (JP); Masashi Mori, Tokyo (JP)

Correspondence Address: William S. Frommer, Esq.;FROMMER LAWRENCE & HAUG LLP, 745 Fifth Avenue, New York, NY, 10151, US

(21) Appl. No.: 11/880,632

(22) Filed: Jul. 23, 2007

(30) Foreign Application Priority Data
Jul. 24, 2006 (JP) 2006-201266

(51) Int. Cl. G09G 5/00

(52) U.S. Cl. 345/581

(57) ABSTRACT

An image-displaying system has a sending apparatus that sends image quality information for adjusting image quality of an image in reply to a request, and an image-displaying apparatus that displays the image based on the image information received from the sending apparatus. The image-displaying apparatus includes receiving device that receives at least program information indicating a genre of an image and information on the image, image-processing device that performs processing relative to image quality of the information on the image received by the receiving device, input-controlling device that controls input of image quality information for adjusting image quality of the image through a transmission medium based on the program information received by the receiving device, and image-quality-setting device that sets the image quality processed in the image-processing device by using the image quality information input by the input-controlling device.

### CROSS REFERENCES TO RELATED APPLICATIONS

The present invention contains subject matter related to Japanese Patent Application JP 2006-201266 filed in the Japanese Patent Office on Jul. 24, 2006, the entire contents of which being incorporated herein by reference.

### BACKGROUND OF THE INVENTION

1. Field of the Invention

This invention relates to an image-displaying system, an image-displaying apparatus, and an image-displaying method. It, more particularly, relates to a television receiver or the like in which image quality of a displayed image can be adjusted.

2. Description of Related Art

A digital television receiver equipped with image quality adjustment function has recently provided with some image quality adjustment modes in order to adjust its displayed image quality and enjoy an optimal displayed image that a viewer suits. For example, the image quality adjustment modes such as a dynamic mode, a standard mode, and a custom mode are provided. A user selects one from these modes by means of his or her remote control operation to set it in the television receiver with these modes being switched. The user then saves the set mode. An image is then displayed based on image quality data of the saved mode. As the image quality data, various kinds of information such as RGB gain, RGB bias is set in addition to basic sets of picture, brightness, contrast, sharpness, hue, etc.

The user may change any sets of image quality data of each mode to meet his or her taste. For example, if the user changes the sets of the image quality data of the custom mode to his or her tasted contrast or sharpness value with him or her viewing a screen in the television display, such the tasted value overwrites any existing value and is saved on any storage media. When the user selects the custom mode, image information is adjusted based on the saved image quality data so that an image can be displayed. This enables the user to enjoy the displayed image with his or her tasted image quality.

Nowadays, the digital television receiver can receive plural kinds of image signals. For example, such the image signal contains a terrestrial analog signal, a terrestrial digital signal, a broadcasting satellite (BS) digital signal, a communication satellite (CS) 1 digital broadcast signal, and a CS 2 digital broadcast signal. The digital television receiver may have plural image input terminals. The image input terminal contains video 1 through 3 input terminals, component 1 through 3 input terminals, high-definition multimedia interface (HDMI) 1 through 3 input terminals, and a personal computer (PC) input terminal. The above-mentioned image quality adjustment modes may be set for every image signal or every image input terminal and sets of the image quality data may be also changed.

Japanese Patent Application Publication No. 2002-158941 has discloses a digital television receiver equipped with image quality adjustment function (see page 3 and FIG. 3) in which a mage-quality-controlling apparatus is provided. The mage-quality-controlling apparatus automatically controls an image quality of output image in the television receiver or the like based on the program genres. The mage-quality-controlling apparatus is provided with an image quality controller that controls its image quality to adjust an image quality of a displayed image automatically based on image-quality-setting information (image quality data) adjusted by a user according to a program genre obtained from a received signal. This enables a user to view and hear the program with user's desired optimal image quality based on a genre of the selected program.

### SUMMARY OF THE INVENTION

In each of the above digital television receivers, set values of the image quality data alter by means of the user's remote control operation or the like. The set values of the image quality data contains many items of information including RGB gain, RGB bias in addition to a basic set of picture, brightness and the like.

Accordingly, if it is possible to set image quality data finely, items to be set on the image quality data and special terms used therefor may be considerably increased. A user who is not interested so much in image quality takes a lot of time to change the set values of the image quality data. It may be thus difficult that he or she updates the image quality data into desired one.

FIG. 1 shows an example of each of the image quality adjustment modes in the image quality data 41 as related art. The image quality data shown in FIG. 1 contains three species of image quality adjustment modes such as a dynamic mode 41a, a standard mode 41b, and a custom mode 41c. NVRAM for storing image quality data of the above image quality adjustment modes 41a through 41c has a volume of about 20 bytes for each mode. The image quality data of these image quality adjustment modes 41a through 41c are normally prepared for every genre of input program.

Accordingly, each time the genre of input program is increased, the NVRAM has a newly additional volume of increased about 60 bytes. Further, each time an image quality set item of one byte is increased by one, the NVRAM has a newly additional volume of three bytes for each input program. Thus, if it is possible to set each of the items of the image quality data finely for every genre of input program, items to be set on the image quality data may be considerably increased so that the NVRAM can have a considerably increased volume to store such the image quality data.

It is conceivable to restrain a full volume of the NVRAM to store the image quality data by selecting a coefficient relative to a rate of change of gain against a signal characteristic of a standard television signal for every position of each channel and storing the selected coefficient so that signal gain of the television signal for every position can be changed to a signal gain based on the corresponding television signal, thereby decreasing a volume of the data to be stored in a memory for every position. It, however, is difficult for such the method to deal with a quadric-functionally increased volume of the image quality data to be stored in the NVRAM by means of increases of the genres of input programs and the image quality set items of the image quality data.

There are various kinds of program genres that a user can view and hear through the same input but, in the example shown in FIG. 1, only three image quality adjustment modes may be set for every program. This makes it clear that the user is difficult to view and hear the programs with their optimal image qualities.

It is desirable to provide an image display system, an image display apparatus, and an image-displaying method, which are capable of providing an image that suits a viewer's taste for every program genre so that the viewer can enjoy the image and of updating image quality data easily.

According to an embodiment of the present invention, there is provided an image-displaying apparatus containing receiving device that receives at least program information indicating a genre of an image and information on the image and image-processing device that performs processing relative to image quality of the information on the image received by the receiving device. The image-displaying apparatus also contains input-controlling device that controls input of image quality information for adjusting image quality of the image through a transmission medium based on the program information received by the receiving device, and image-quality-setting device that sets the image quality processed in the image-processing device by using the image quality information input by the input-controlling device.

In this embodiment of the invention, the receiving device receives at least program information indicating a genre of an image and information on the image. The input-controlling device controls input of image quality information for adjusting image quality of the image through a transmission medium based on the received program information. For example, the transmission medium contains a communication line, electromagnetic wave, and an information transmission channel. The image-quality-setting device sets the image quality processed in the image-processing device by using the image quality information input by the input-controlling device. The image-processing device performs any processing relative to image quality of the information on the image based on the image quality information corresponding to the program information. This enables a viewer to enjoy an image to meet his or her taste for every genre of program and to update any existing image quality information easily by using any previously adjusted image quality information.

According to another embodiment of this invention, there is provided an image-displaying method including the steps of receiving at least program information indicating a genre of an image, inputting image quality information for adjusting image quality of the image through a transmission medium based on the received program information, selecting the image quality information from the input image quality information based on the program information, and performing the image information based on the selected image quality information.

In this embodiment of the invention, at least program information indicating a genre of an image is received. The image quality information is then input for adjusting image quality of the image through a transmission medium based on the received program information. The image quality information is further selected from the input image quality information based on the program information. The processing relative to image quality of the information on the image is performed based on the selected image quality information. This enables a viewer to enjoy an image to meet his or her taste for every genre of program and to update any existing image quality information easily by using any previously adjusted image quality information.

According to further embodiment of this invention, there is provided an image-displaying apparatus containing a set number of terminals that receives information on an image, image-processing device that performs processing relative to image quality of the information on the image received through the terminals, input-controlling device that controls input of image quality information for adjusting image quality of the image through a transmission medium, relative to the information of the image, and image-quality-setting device that sets the image quality processed in the image-processing device by using the image quality information input by the input-controlling device. The image-quality-setting device receives an image-switching signal and the image quality is set in the image-processing device based on the input image-switching signal.

In this embodiment of the invention, the input-controlling device controls input of image quality information for adjusting image quality of the image through a transmission medium, relative to the information on the image output from the image-outputting device that outputs the information on the image. The image-quality-setting device sets the image quality processed in the image-processing device by using the image quality information input by the input-controlling device. Particularly, the image-quality-setting device receives an image-switching signal when the image-outputting device is switched and the image quality is set in the image-processing device based on the received image-switching signal.

The image-processing device performs any processing relative to image quality of the information on the image output from the image-outputting device based on the image quality information. This enables a viewer to enjoy an image to meet his or her taste for every switch of inputs and to update any existing image quality information easily by using any previously adjusted image quality information.

According to still another embodiment of this invention, there is provided an image-displaying method including the steps of inputting image quality information for adjusting image quality of an image through a transmission medium, inputting an image-switching signal for switching input of the image after inputting the image quality information, selecting the image quality information based on the input image-switching signal, and performing processing relative to image quality of the information on the image based on the selected image quality information.

In this embodiment of the invention, image quality information is input for adjusting image quality of an image through a transmission medium. An image-switching signal for switching input of the image is input after inputting the image quality information. The image quality information is then selected based on the input image-switching signal. The processing relative to image quality of the information on the image is performed based on the selected image quality information. This enables a viewer to enjoy an image to meet his or her taste for every switch of image inputs and to update any existing image quality information easily by using any previously adjusted image quality information.

According to still further embodiment of this invention, there is provided an image-displaying system containing a sending apparatus that sends image quality information for adjusting image quality of an image in reply to a request, and an image-displaying apparatus that displays the image based on the image quality information received from the sending apparatus. The image-displaying apparatus includes receiving device that receives at least program information indicating a genre of an image and information on the image, and image-processing device that performs processing relative to image quality of the information on the image received by the receiving device. The image-displaying apparatus also includes input-controlling device that controls input of image quality information for adjusting image quality of the image through a transmission medium based on the program information received by the receiving device, and image-quality-setting device that corresponds the image quality information input by the input-controlling device to the program information and sets image quality of the information on the image in the image-processing device based on the program information.

In this embodiment of the invention, the sending apparatus sends image quality information for adjusting image quality of an image in reply to a request. In the image-displaying apparatus, at least program information indicating a genre of an image is received. The image quality information is then input for adjusting image quality of the image through a transmission medium based on the received program information. The image quality information is further selected from the input image quality information based on the program information. The information on the image is processed based on the selected image quality information. Thus, the image-displaying apparatus displays the image based on the image information received from the sending apparatus. This enables a viewer to enjoy an image to meet his or her taste for every genre of programs and to update any existing image quality information easily by using any previously adjusted image quality information.

According to additional embodiment of this invention, there is provided an image-displaying system containing a sending apparatus that sends image quality information for adjusting image quality of an image in reply to a request, and an image-displaying apparatus that displays the image based on the image quality information received from the sending apparatus. The image-displaying apparatus includes a set number of terminals that is connected to the image-outputting device and receives information on an image from an image-outputting device, image-processing device that performs processing relative to image quality of the information of the image received through the terminals, input-controlling device that controls input of image quality information for adjusting image quality of the image through a transmission medium, relative to the information on the image received from the image-outputting device, and image-quality-setting device that sets the image quality processed in the image-processing device by using the image quality information input by the input-controlling device. The image-quality-setting device receives an image-switching signal when the image-outputting device that outputs the information on the image is switched. The image quality is set in the image-processing device based on the input image-switching signal.

In this embodiment of the invention, the sending apparatus sends image quality information for adjusting image quality of an image in reply to a request. In the image-displaying apparatus, the image quality information for adjusting image quality of the image is input through a transmission medium, relative to the information on the image received from the image-outputting device. The image quality to be processed in the image-processing device is then by using the image quality information input by the input-controlling device. Any processing relative to image quality of the information of the image received through the terminals is performed. If the image-quality-setting device receives an image-switching signal when the image-outputting device that outputs the information on the image is switched, the image quality is set in the image-processing device based on the input image-switching signal. This enables a viewer to enjoy an image to meet his or her taste for every switch of inputs and to update any existing image quality information easily by using any previously adjusted image quality information.

The concluding portion of this specification particularly points out and directly claims the subject matter of the present invention. However, those skilled in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIG. 1 is a diagram for showing an example of each item of image quality data as related art;

FIG. 2 is a block diagram for illustrating a configuration of a first embodiment of an image-displaying system with an image quality adjustment function according to the invention;

FIG. 3 is a diagram for illustrating an example of each item of image quality data (a group of the image quality data) for every genre of the programs;

FIG. 4 is a diagram for illustrating an example of a program genre table in which the program genre is classified in a digital broadcast;

FIG. 5 is a diagram for showing an example of an image quality data selection table, based on which the image quality data is selected;

FIG. 6 is a diagram for showing a linkage example of input genres and items of the image quality data;

FIG. 7 is a diagram for illustrating a display example in a display of a digital television receiver (hereinafter referred to as “DTV1”) when image quality data is obtained from a storage server and a manipulation example of a user;

FIG. 8 is a diagram for illustrating a display example in a browser when image quality data is obtained from the storage server and a manipulation example (No. 1) of a user;

FIG. 9 is a diagram for illustrating a display example in the browser when image quality data is obtained from the storage server and a manipulation example (No. 2) of a user;

FIG. 10 is a diagram for illustrating a display example in the browser when image quality data is obtained from the storage server and a manipulation example (No. 3) of a user;

FIG. 11 is a diagram for illustrating a display example in the browser when image quality data is obtained from the storage server and a manipulation example (No. 4) of a user;

FIG. 12 is a diagram for illustrating a display example in the browser when image quality data is obtained from the storage server and a manipulation example (No. 5) of a user;

FIG. 13 is a flowchart for showing operations of the storage server;

FIG. 14 is a flowchart for showing operations of the DTV1;

FIG. 15 is a diagram for illustrating a display example in a display of the DTV1 when image quality data is obtained from a USB memory and a manipulation example (No. 1) of a user;

FIG. 16 is a diagram for illustrating a display example in the display of the DTV1 when image quality data is obtained from the USB memory and a manipulation example (No. 2) of a user;

FIG. 17 is a diagram for illustrating a display example in the display of the DTV1 when image quality data is obtained from the USB memory and a manipulation example (No. 3) of a user;

FIG. 18 is a diagram for illustrating a display example in a display of the DTV1 when image quality data is output to a USB memory and a manipulation example (No. 1) of a user;

FIG. 19 is a diagram for illustrating a display example in the display of the DTV1 when image quality data is output to the USB memory and a manipulation example (No. 2) of a user;

FIG. 20 is a diagram for illustrating an example of writing image quality data to a text file;

FIG. 21 is a diagram for illustrating an example of reading image quality data from text files; and

FIG. 22 is a flowchart for showing a check example of text files.

### DESCRIPTION OF PREFERRED EMBODIMENTS

The following will describe preferred embodiments of an image-displaying system, an image-displaying apparatus, and an image-displaying method according to the invention with reference to the attached drawings.

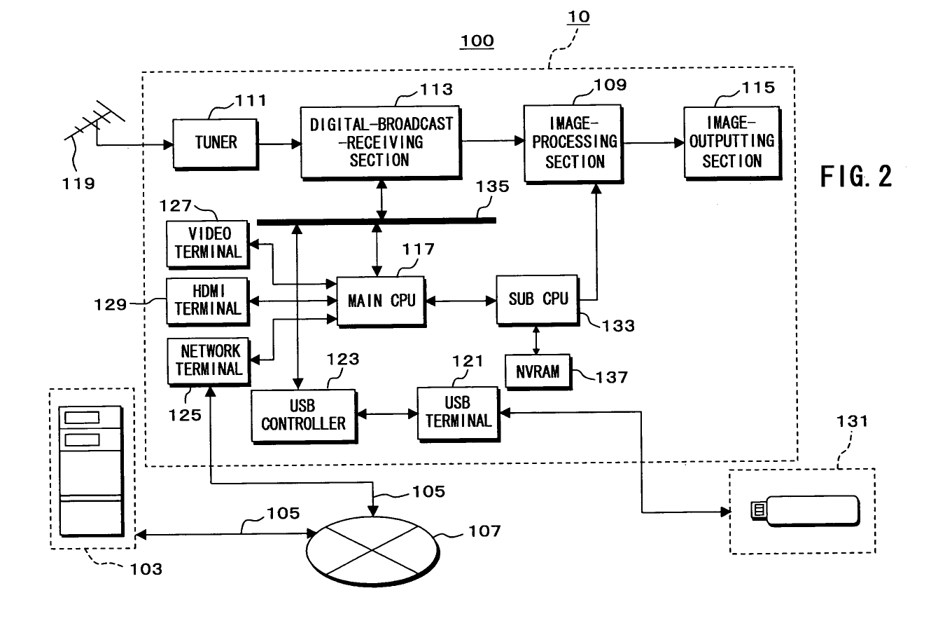

FIG. 2 illustrates a configuration of an embodiment of an image-displaying system 100 with an image quality adjustment function according to the invention. The image-displaying system 100 shown in FIG. 2 contains a digital television receiver (hereinafter, referred to as “DTV1”) 101, a storage server 103 for image quality data, and communication lines 105. The image quality data (image quality information) is referred to as “various kinds of data for adjusting image quality of an image” such as various kinds of data for adjusting brightness, contrast, color depth and the like.

The storage server 103 functions as a sender and is connected to the DTV1 through the communication lines 105. The storage server 103 sends the image quality data to the DTV1. For example, when receiving a request signal for acquiring image quality data from the DTV1, the storage server 103 sends the image quality data to the DTV1 via the communication lines 105 and the Internet 107.

The DTV1 101 is an image-displaying apparatus with any image quality adjustment function. The DTV1 101 receives at least program information indicating a genre of image and receives the image quality data relative to the received program information from the storage server 103 to set image quality based on the program information in an image-processing section 109 built therein where the image is processed by using the received image quality data. It is to be noted that the program information is referred to as “information such that at least genre information of the image (program) is acquired from an event information table (EIT) contained in a service information (SI) table” in a standard, STD-B10 of the association of radio industries and businesses (ARIB) in Japan. This genre information of the program includes “News/Press Reports” and “Sports”.

The DTV1 101 contains a tuner 111, a digital-broadcast-receiving section 113, the image-processing section 109, an image-outputting section 115, and a main central processing unit (CPU) 117. The tuner 111 is connected to an antenna 119 for receiving ultra-high frequency (UHF) electric wave and tunes a broadcast signal received by the antenna 119 to a desired channel to transmit it to the digital-broadcast-receiving section 113.

The digital-broadcast-receiving section 113 functions as a receiving device. The digital-broadcast-receiving section 113 is connected to the tuner 111 and receives program information relative to the tuned broadcast signal to a desired channel among the received broadcast signal. The digital-broadcast-receiving section 113 acquires image information from the received broadcast signal and transmits the image information to the image-processing section 109 and the program information to the main CPU 117.

The image-processing section 109 functions as an image-processing device and is connected to the digital-broadcast-receiving section 113. The image-processing section 109 receives the image information from the digital-broadcast-receiving section 113 to perform any processing relative to image quality of the received image information and transmits the processed image information to the image-outputting section 115. The image-outputting section 115 is connected to the image-processing section 109 and receives the image information from the mage-processing section 109 to output the received image information and display it on a display as an image.

The DTV1 also contains a universal series bus (USB) terminal 121, a USB controller 123, a network terminal 125, a video terminal 127, a high-definition multimedia interface (HDMI) terminal 129. The USB terminal 121 constitutes an information transmission channel and a USB memory 131 or the like is inserted into the USB terminal 121. The USB memory 131 stores any image quality data and the like.

The USB controller 123 is connected to the USB terminal 121 to control it. For example, when the USB memory 131 is inserted into the USB terminal 121, the USB controller 123 controls the USB memory 131 to read the image quality data out thereof and transmit it to the main CPU 117. The network terminal 125 is connected to the communication lines 105 that are also connected to the storage server 103 via the Internet 107.

The video terminal 127 is connected to a video recorder (image output apparatus), not shown. The main CPU 117 functions as input-controlling device and is connected to the video terminal 127. The main CPU 117 controls input of the image information reproduced by the video recorder. The HDMI terminal 129 is connected to an image apparatus (image-outputting apparatus), not shown. The main CPU 117 is also connected to the HDMI terminal 129 and controls input of the image information from any image apparatus and output of the image information received via the video terminal 127 and the HDMI terminal 129 toward the image-processing section 109. The main CPU 117 controls input of the image quality data relative to the image information output from the video recorder or the image apparatus, through the USB terminal 121 or the like. The mage-processing section 109 receives the image information and performs any processing on the image information, based on the image quality data received via the USB terminal 121

The DTV1 further contains a sub CPU 133, a peripheral component interconnection (PCI) bus 135, and non-volatile random access memory 137.

The main CPU 117 is connected to the digital-broadcast-receiving section 113 through the PCI bus 135 and receives the program information from the digital-broadcast-receiving section 113. The main CPU 117 is also connected to the USB controller 123 and the network terminal 125 and controls them to input the image quality data relative to the program information through the transmission medium. In this embodiment, the transmission medium contains the communication lines 105, electromagnetic wave, and the USB terminal 121. For example, when the USB memory 131 storing the image quality data is inserted into the USB terminal 121, the USB controller 123 controls the USB memory 131 to read the image quality data and transmit it to the main CPU 117. This enables any existing image quality data to be easily updated by using the previously adjusted image quality data. The main CPU 117 controls transmission of the input image quality data and the program information to the sub CPU 133.

The sub CPU 133 functions as the image-quality-setting device and is connected to the main CPU 117. The sub CPU 133 controls the NVRAM 137 to store the input image quality data and the program information from the main CPU 117. The NVRAM 137 functions as the storage device and is connected to the sub CPU 133 to store the input image quality data and the program information. The sub CPU 133 controls the NVRAM 137 to read the image quality data stored therein and set image quality in the image processing section 109 based on the genre information of the program by using the image quality data stored the NVRAM 137. The image-processing section 109 performs any image processing on the input information on the image to meet the set image quality and transmits the processed information on the image to the image-outputting section 115. This enables image quality of an image to be adjusted to meet user's taste for every genre of the program by using the image quality data received from the USB memory 131, thereby allowing the image to be displayed with optimal image quality for every genre of the program.

The sub CPU 133 also sets the image quality data relative to each of the pieces of image information received through the video terminal 127 and the HDMI terminal 129. For example, if input is switched to a video, the sub CPU 133 controls the image-processing section 109 to set the image quality to be processed therein relative to the image quality data received through the USB terminal 121 and the like, based on an image-switching signal received from the main CPU 117. This enables image quality of an image to be adjusted to meet user's taste for every input switching of the input image.

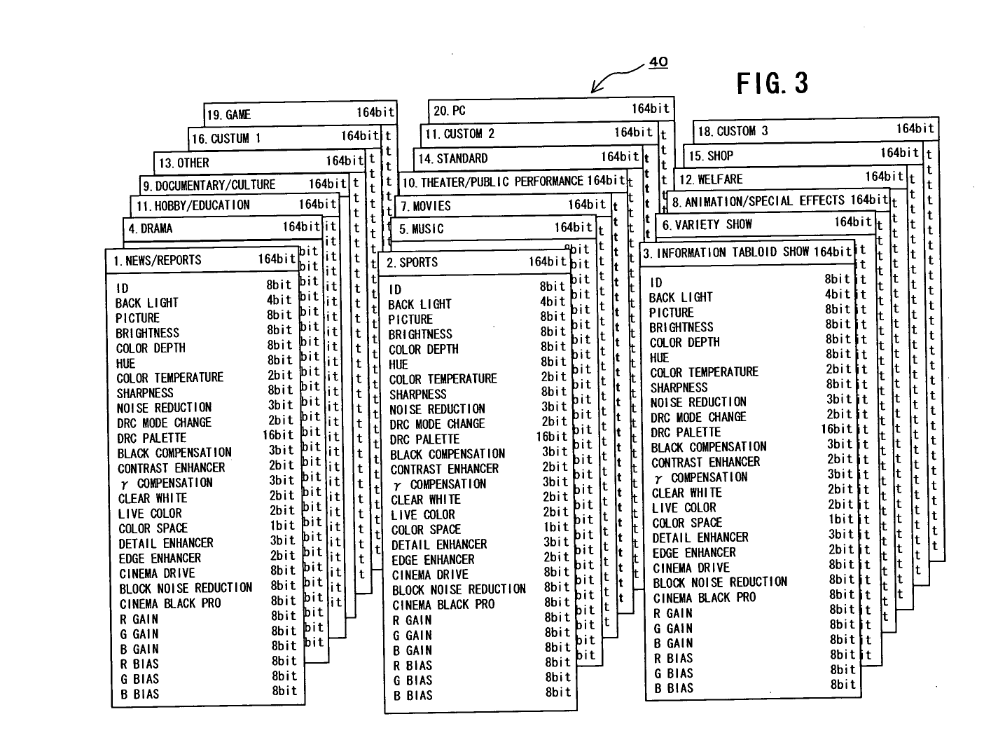

FIG. 3 illustrates an example of each item of image quality data for every genre of the program (a group 140 of the image quality data). Each item of the image quality data illustrated in FIG. 3 is provided for every piece of the genre information of the programs in EIT. For example, the genre information of the programs in EIT presently contains a total of 13 species of genre information such as “News/Reports”, “Drama”, “Hobby/Education”, and “Documentary/Culture”.

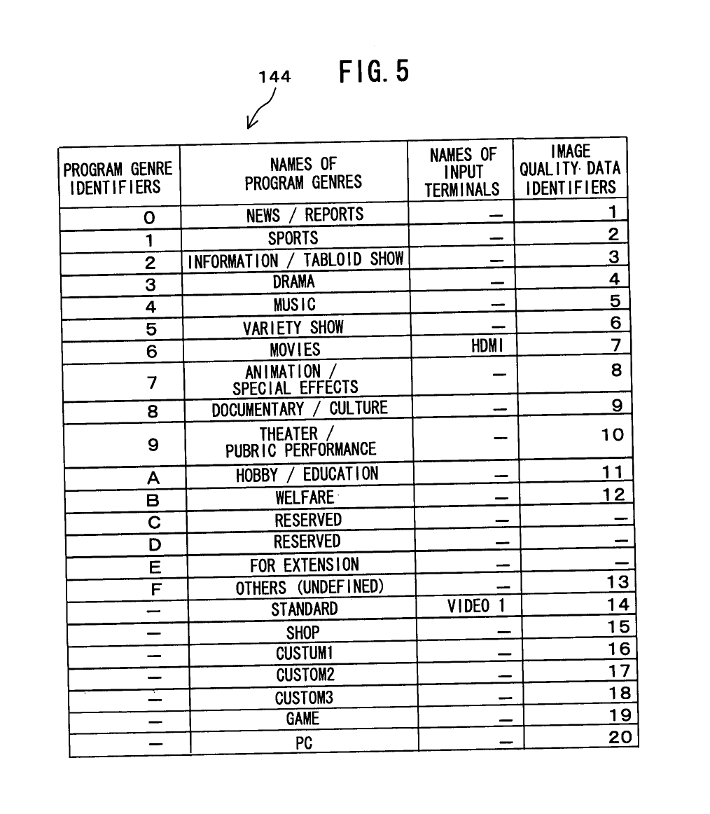

Further, each item of the image quality data illustrated in FIG. 3 is also provided for every image input terminal such as the video terminal 127 and HDMI terminal 129. For example, “Standard”, “Shop”, “Custom 1”, “Custom 2”, “Custom 3”, “Game”, and “PC” are respectively provided. Optional or different image quality data other than the above-mentioned item of the image quality data illustrated in FIG. 3 may be prepared. The group 140 of the image quality data is exclusively managed under an image quality data selection table 144 shown in FIG. 5.

Items of the image quality data contain, for example, “Identifier (ID)” with 8 bits, “Back Light” with 4 bits, “Picture” with 8 bits, “Brightness” with 8 bits, “Color Depth” with 8 bits, “Hue” with 8 bits, “Color Temperature” with 2 bits, “Sharpness” with 8 bits, “Noise Reduction” with 3 bits, digital reality creation (DRC) Mode Change” with 2 bits, “DRC palette” with 16 bits, “Black Compensation” with 3 bits, “Contrast Enhancer” with 2 bits, “Gamma Compensation” with 3 bits, “Clear White” with 2 bits, “Live Color” with 2 bits, “Color Space” with 1 bit, “Detail Enhancer” with 3 bits, “Edge Enhancer” with 2 bits, “Cinema Drive” with 8 bits, “Block Noise Reduction” with 8 bits, “Cinema Black Pro” with 8 bits, “RGB Gains” with 24 bits (8 bits multiplied by 3), and “RGB Biases” with 24 bits (8 bits multiplied by 3). The above bit numbers (a unit of bits) indicate a capacity of data storage, respectively. Configurations of items of the above image quality data of the genre information of the programs and the image input terminal are identical to each other.

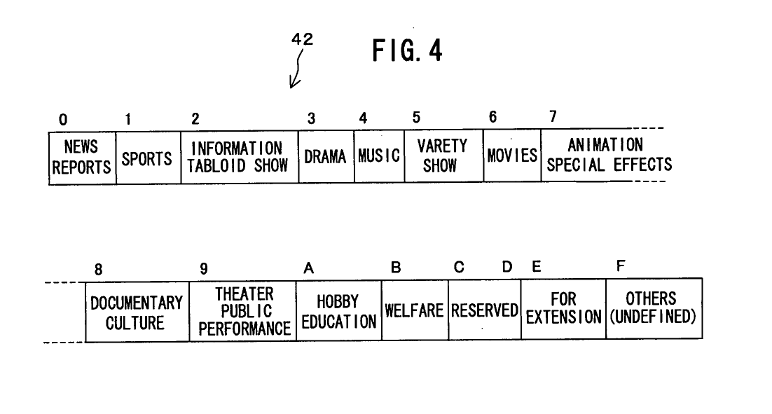

FIG. 4 illustrates an example of a program genre table 142 in which the program genre is classified in a digital broadcast. The program genre table 142 illustrated in FIG. 4 is prepared by picking the program genre information out of EIT contained in SI table.

The program genre table 142 contains pieces of the program genre information such as “News/Reports”, “Sports”, “Information/Tabloid Show”, “Drama”, “Music”, “Variety Show”, “Movies”, “Animation/Special Effects”, “Documentary/Culture”, “Theater/Public Performance”, “Hobby/Education”, “Welfare”, “Reserved”, “For Extension” and “Others (Undefined)”.

A broadcasting station broadcasts information on the SI table. The UHF antenna 119 of DTV1 101 receives the information on the SI table and NVRAM 137 stores the received information on the SI table. Electronic program guide (EPG) and the like are prepared based on the stored information on the SI table. To EPG, any channel information and the program genre information for each piece of broadcast time are linked.

For example, if a user changes a television channel to a 3rd channel thereof, the sub CPU 133 refers to EPG stored in NVRAM 137 and acquires the program genre information such as “Sports” corresponding to the 3rd channel from the referred EPG. The sub CPU 133 refers to the image quality data selection table 144 shown in FIG. 5 by using a program genre identifier of the acquired program genre information such as “Sports” as a search key and selects an image quality data identifier 2. The sub CPU 133 then transmits image quality data corresponding to the selected image quality data identifier 2 of “Sports” to the image-processing section 109. The image-processing section 109 receives the image quality data corresponding to the selected image quality data identifier 2 of “Sports” and adjusts brightness, contrast, color depth and the like of the information on the image to transmit the adjusted information on the image to the image-outputting section 115. Thus, the sub CPU 133 acquires the program genre information to select the image quality data.

FIG. 5 shows an example of the image quality data selection table 144, based on which the image quality data is selected. The image quality data selection table 144 is stored in NVRAM 137 and contains items of “Program Genre Identifiers”, “Names of Program Genres”, “Names of Input Terminals”, and “Image Quality Data Identifier”.

In item of “Program Genre Identifiers”, identifiers in the program genre table 142 illustrated in FIG. 4 are registered. For example, these identifiers include 0 through 9 and A through F. In item of “Names of Program Genres”, names of the program genres in the program genre table 142 each corresponding to any program genre identifiers are registered. In this example, for example, “News/Reports” is registered corresponding to the program genre identifier 0 and “Sports” is registered corresponding to the program genre identifier 1.

In item of “Names of Input Terminals”, names of image input terminals are registered. For example, “HDMI” and “Video 1” are registered. In item of “Image Quality Data Identifier”, identifiers of the image quality data illustrated in FIG. 3 are registered. In this example, these identifiers includes 1 through 20 each corresponding to any program genre identifiers and any names of input terminals. For example, the program genre identifier 0 corresponds to the image quality data identifier 1, namely, the image quality data of the name of program genre, “News/Reports” illustrated in FIG. 3 and the image quality data identifier 7 corresponds to the name of input terminal, “HDMI”, namely, the image quality data of name of program genre, “Movies”. These correspondences enable the image quality data to be identified for every program genre identifier or for every input terminal.

It is to be noted that these correspondences may be changed by a user. For example, the correspondence between the name of input terminal, “HDMI” and the image quality data identifier 7 (the image quality data of movies) may be changed to that between the name of input terminal, “HDMI” and the image quality data identifier 5 (the image quality data of music).

For example, the user manipulates DTV1 101 to display a screen for change of the correspondences, not shown. After displaying the screen for change of the correspondences, the user manipulates DTV1 101 to change the correspondence between the name of input terminal, “HDMI” and the image quality data identifier 7 (the image quality data of movies) to that between the name of input terminal, “HDMI” and the image quality data identifier 5 (the image quality data of music). In this case, the main CPU 117 controls the NVRAM 137 to transfer “HDMI” in the item of “Names of Input Terminals” of the image quality data selection table 144 that is stored in the NVRAM 137 corresponding to the item of name of program genre “Movies” to that corresponding to the item of name of program genre “Music”. This enables any image information input through the HDMI terminal 129 to be adjusted based on the image quality data of “Music” after transferring it, thereby allowing any image quality of an image to be selected to meet user's taste to display it on a screen. It is to be noted that the program genres and the image input terminals are referred to as “input genres” hereinafter.

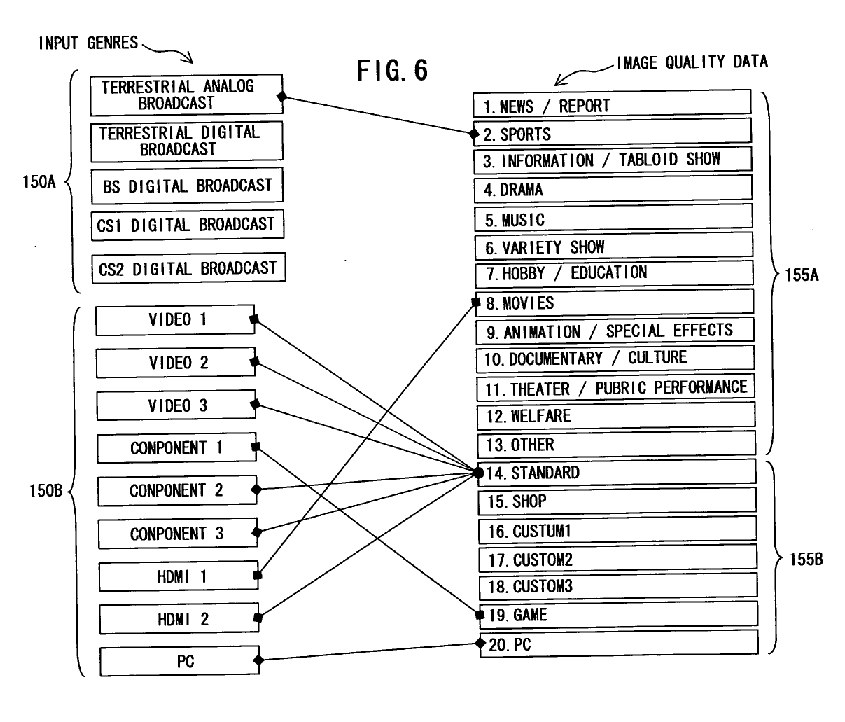

FIG. 6 shows a linkage example of the input genres and the items of the image quality data. The input genres includes input genres 150A that are available for image quality sommelier function and input genres 150B that are unavailable for the image quality sommelier function. The image quality sommelier function is referred to as “function to refer to and search the image quality data selection table 144 based on the input program genre information to select any desired image quality data from the group 140 of the image quality data illustrated in FIG. 3”.

Input genres 150A that is available for image quality sommelier function is of input genres on a terrestrial analog broadcast, a terrestrial digital broadcast, a BS digital broadcast, a CS1 digital broadcast, and a CS2 digital broadcast. For example, in the terrestrial digital broadcast, the tuner 111 sets a television channel to 3rd channel, the main CPU 117 in DTV1 101 transfers channel information of 3rd channel to the sub CPU 133. The sub CPU 133 receives the channel information of 3rd channel and refers to EPG stored in the NVRAM 137 to acquire from the referred EPG the program genre identifier, for example, 1 corresponding to the name of the program genre, “Sports” that corresponds to the channel information of 3rd channel at a set period of time.

After acquiring the program genre identifier 1, the sub CPU 133 refers to the image quality data selection table 144 shown in FIG. 5 to search items of the program genre identifiers by using the program genre identifier 1 as a search key. The sub CPU 133 then obtains the image quality data identifier 2 corresponding to the program genre identifier 1 and transmits image quality data corresponding to the obtained image quality data identifier 2 relative to “Sports” among the group 140 of the image quality data stored in the NVRAM 137 to the image-processing section 109. Thus, the sub CPU 133 allows the image quality data to be selected by obtaining the program genre information. This is identical to each of the cases of the terrestrial analog broadcast, the BS digital broadcast, the CS1 digital broadcast, and the CS2 digital broadcast.

Input genres 150B that is unavailable for image quality sommelier function is of input genres on a video 1, a video 2, a video 3, a component 1, a component 2, a component 3, HDMI 1, HDMI 2, and PC. For example, if a user manipulates DTV1 101 to switch input thereof to the video 1, the main CPU 117 allows receipt of an image-switching signal to switch input thereof to the video 1, and transmits any video input signal to the sub CPU 133 at the same time. The sub CPU 133 refers to the image quality data selection table 144 shown in FIG. 5 based on the video input signal to search items of the names of input terminals by using the name of input terminal “Video 1” as a search key. The sub CPU 133 then obtains the image quality data identifier 14 corresponding to the name of searched input terminal “Video 1” and transmits to the image-processing section 109 image quality data corresponding to the obtained image quality data identifier 14 relative to the name of program genre “Standard” among the group 140 of the image quality data stored in the NVRAM 137. Thus, the sub CPU 133 allows acquisition of the image switch signal and selection of the image quality data.

This is identical to each of the video 2, the video 3, the component 1, the component 2, the component 3, the HDMI 1, the HDMI 2, and the PC. In this example, the component 1 of the input genres is linked to an item, “Game” of the image quality data and the PC of the input genres is linked to an item, “PC” of the image quality data. Thus, optimal image quality data is automatically selected from the considerably increased image quality modes based on the image quality sommelier function, so that the user can view and hear the program with the optimal image quality with him or her doing nothing.

The image quality data 155A that can be automatically selected based on the image quality sommelier function contains items of the image quality data indicated by the image quality data identifiers 1 through 13 of the image quality data selection table 144 shown in FIG. 5. The image quality data 155B that has invalid image quality sommelier function contains items of the image quality data indicated by the image quality data identifiers 14 through 20 which a user can set. The user can select the image quality data optionally on a real-time basis relative to his or her viewed and heard program.

For a user who does not desire to switch the image quality data automatically, it is possible for the user to choose the image quality sommelier function freely to OFF. For example, if DTV1 101 is provided with an ON/OFF switch button, not shown, for the image quality sommelier function and the user pushes the ON/OFF switch button, the main CPU 117 receives an ON/OFF switch signal. The main CPU 117 controls the sub CPU 133 to set the image quality based on the ON/OFF switch signal. For example, if receiving the OFF switch signal, the main CPU 117 transmits to the sub CPU 133 a signal to read image quality data corresponding to the name of program genre, “Standard” from the NVRAM 137 despite of any input genres. In this moment, the sub CPU 133 transmits the image quality data corresponding to the name of program genre, “Standard” to the image-processing section 109 but if the user changes the television channel, the sub CPU 133 keeps this image quality data.

Further, a method of setting the image quality data automatically based on brightness in a room and a method of setting the image quality data automatically based on brightness or hue in whole of the broadcast screen are conceivable, in addition to a method of switching the image quality data automatically based on the user's viewed and heard program genre information.

Even if a user selects and sets the image quality data other than the automatically selected image quality data while the image quality sommelier function is set ON, the image quality sommelier function switches the image quality data automatically when the program genre alters so that this prevents the image quality data set by the user to his or her desired channel from being linked to this channel and stored in the NVRAM 137. While the image quality sommelier function is set OFF or input has an invalid image quality sommelier function, however, the image quality data selected and set by the user is stored in the NVRAM 137 with it being linked to the input genre.

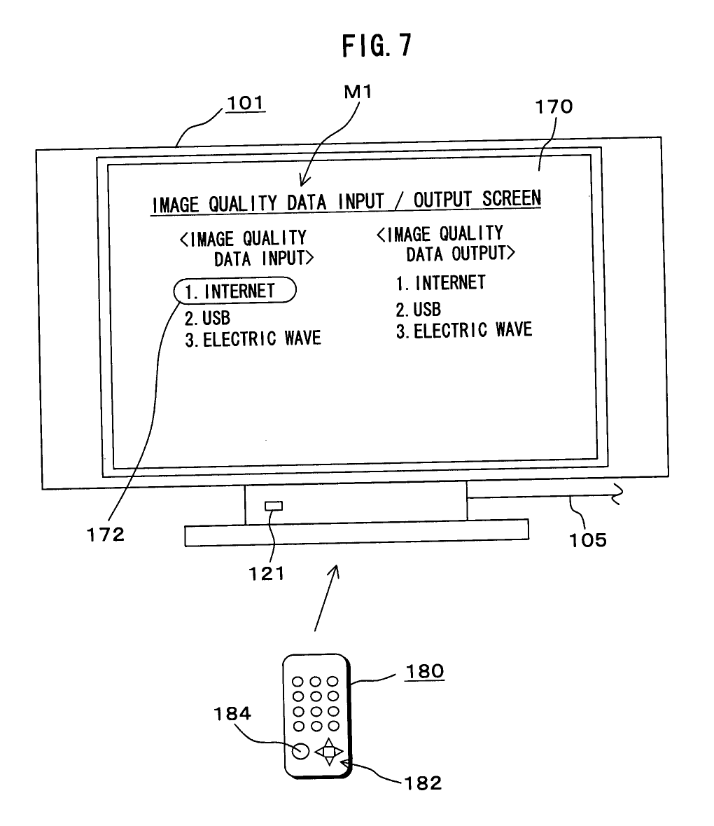

The following will describe an embodiment in which the image quality data is received and transmitted through the Internet. FIGS. 7 through 12 illustrate an embodiment in which the image quality data is received through the Internet 107.

FIG. 7 illustrates a display example in a display 170 of DTV1 101 when image quality data is obtained from the storage server 103 and a manipulation example of a user. The DTV1 101 is provided with a remote controller 180. This remote controller 180 has selection buttons 182 and a decision button 184. The selection buttons 182 are constituted of four triangular buttons each arranged so that they are respectively oriented upward, downward, rightward, and leftward. The image-outputting section 115 of DTV1 101 is provided with a display 170 as illustrated in FIG. 7 and a mark 172 is highlighted at a user's selected item in the display 170. The user uses the selection buttons 182 to move the mark 172 upward, downward, rightward, or leftward to select the his or her desired item, and pushes the decision button 184 to fix the selection. A selection screen for selecting input and/or input of the image quality data is displayed on the display 170 in DTV1 101 shown in FIG. 7. This selection screen is displayed when a switch button, not shown, on the remote controller 180 is manipulated and an image quality data input/output program stored in a hard disk, not shown, or the like boots up on the main CPU 117.

On a top of the display 170, a title M1, “Image Quality Data Input/Output Screen” is displayed. Under the title M1, as the image quality data inputs, the Internet, USB, and electric wave are respectively displayed so that they can be selected and as the image quality data outputs, the Internet, USB, and electric wave are also displayed so that they can be selected.

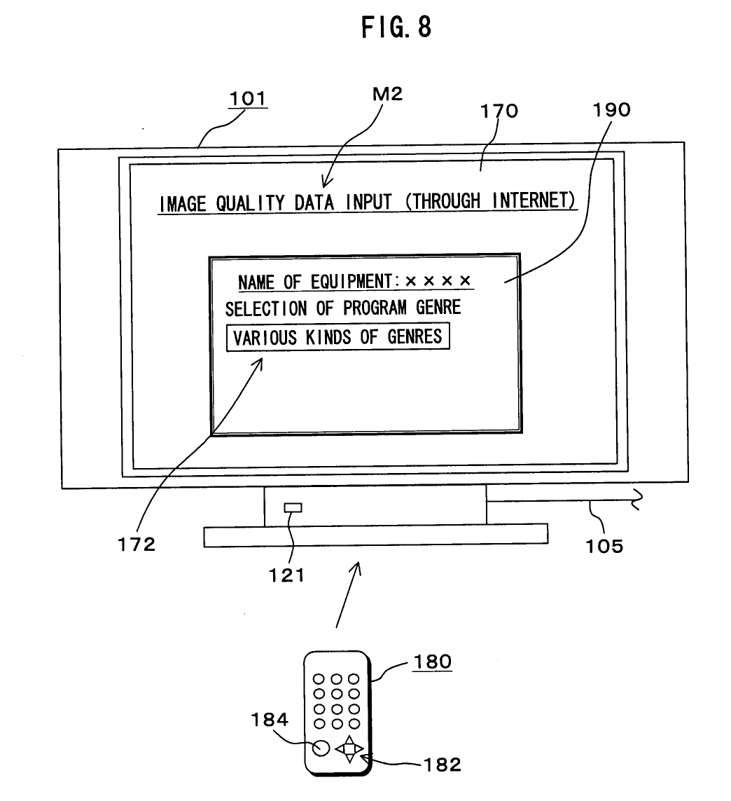

The user first manipulates the selection buttons 182 of the remote controller 180 to set the mark 172 on an item of the Internet as the image quality data input. Next, the user pushes the decision button 184. In this moment, an infrared-rays-receiving section, not shown, of DTV1 101 receives infrared rays from the remote controller 180 to transmit a decision signal to the main CPU 117. The main CPU 117 receives this decision signal to read uniform resource locator (URL) stored in a hard disk, not shown, and connect DTV1 101 to a storage server 103 corresponding to this URL through the network terminal 125, the communication lines 105, and the Internet 107. The main CPU 117 starts up a browser 190 as shown in FIG. 8 after the connection. This enables DTV1 101 to communicate with the storage server 103.

FIG. 8 illustrates a display example in the browser 190 when the image quality data is obtained from the storage server 103 and a manipulation example (No. 1) of the user. The browser 190 is displayed in the display 170 as illustrated in FIG. 8. A pull-down menu for selecting the program genre is displayed on the browser 190. The pull-down menu is displayed when the mark 172 is set on item of the Internet 107 of the image quality data input illustrated in FIG. 7 and the decision button 184 is pushed so that DTV1 101 can be connected to the storage server 103.

On a top of the display 170, a title M2, “Image Quality Data Input (through the Internet)” is displayed. Under the title M2, the browser 190 started up after the connection with the storage server 103 is displayed.

On a top of the browser 190, a name of equipment, “Name of Equipment: XXXX” is displayed. Under the name of equipment, a message, “Selection of Program Genre” is also displayed. Under this message, the pull-down menu is displayed. A user manipulates the selection buttons 182 to set the mark 172 on the pull-down menu (Various Kinds of Genres) and pushes the decision button 184. When the user pushes the decision button 184, a list of items of the names of program genres in the image quality data selection table 144 illustrated in FIG. 5 is pulled downward and displayed. After displayed, the user pushes the selection button 182 oriented downward to select, for example, the name of program genre, “Sports” and then, pushes the decision button 184. This enables the program genre to be selected.

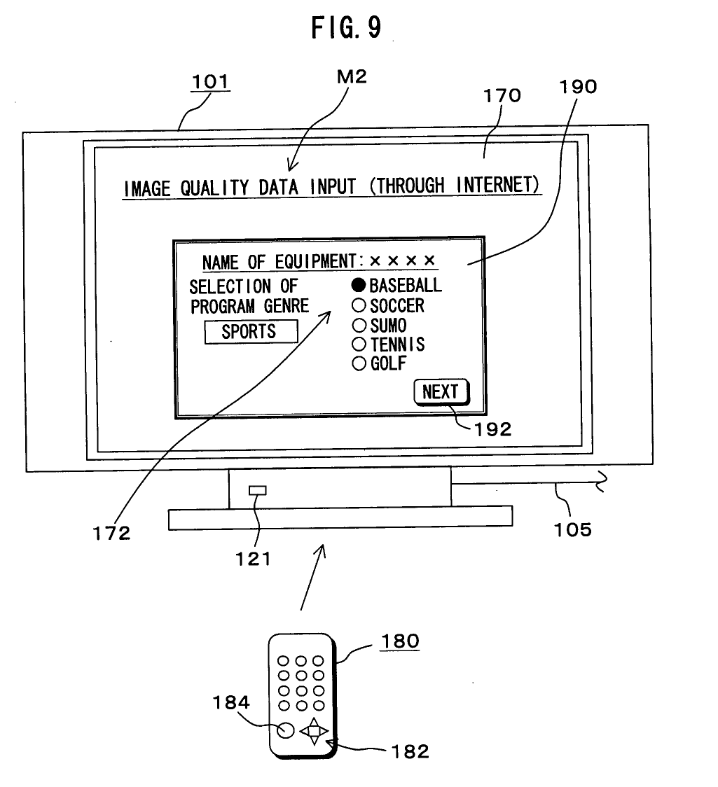

FIG. 9 illustrates a display example in the browser 190 when the image quality data is obtained from the storage server 103 and a manipulation example (No. 2) of the user. A list of the image quality data relative to the selected program genre, “Sports” is displayed on the browser 190 illustrated in FIG. 9. The list is displayed when the user selects the name of program genre, “Sports” on the pull-down menu illustrated in FIG. 8 and pushes the decision button 184.

On a top of the display 170, a title M2, “Image Quality Data Input (through the Internet)” is displayed. Under the title M2, the browser 190 is displayed.

On a top of the browser 190, a name of equipment, “Name of Equipment: XXXX” is displayed. Under the name of equipment, a selection of program genre, “Selection of Program Genre” is also displayed. Under the selection of program genre, the name of program genre, “Sports” selected in FIG. 8 is highlighted and beside the selected program genre, the list of the image quality data relative to the selected program genre, “Sports” is displayed. In this embodiment, the list contains items of the image quality data such as “Baseball”, “Soccer”, “Sumo”, “Tennis”, and “Golf”. One of these items can be selected by setting a radio button. For example, the user pushes the selection buttons 182 to set the mark 172 on the radio button of baseball and pushes the decision button 184. This enables the image quality data relative to the selected program genre, “Sports (Baseball)” to be selected. This is identical in the selections of the image quality data relative to the selected program genres, “Movies (Action)”, “Animation/Special Effects (Fight)” and the like.

On a bottom of the browser 190, a NEXT button 192 is displayed. When finishing the selections of the image quality data, the user sets the mark 172 on this NEXT button 192 and pushes the decision button 184. This enables a next procedure to be shifted.

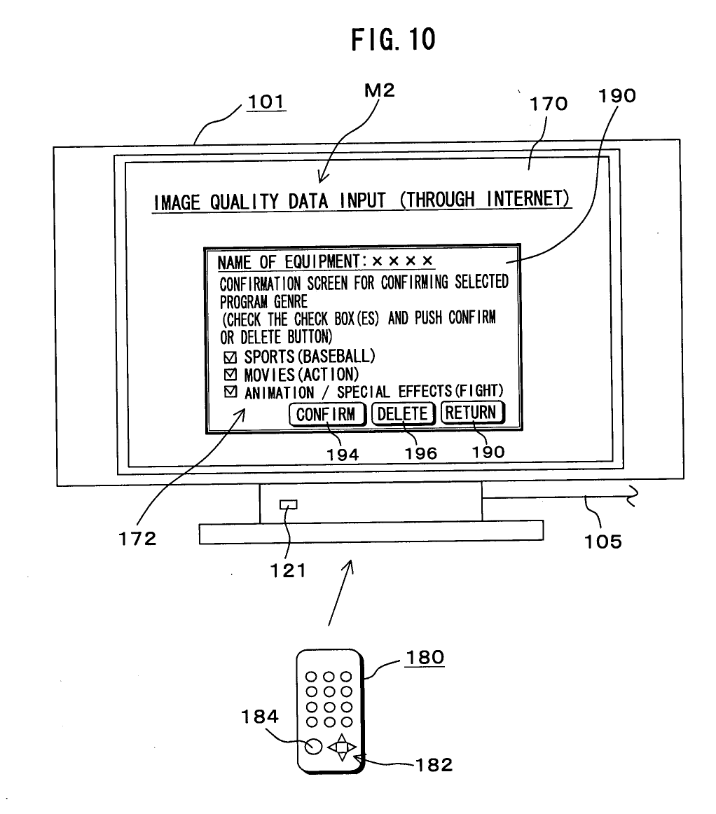

FIG. 10 illustrates a display example in the browser 190 when the image quality data is obtained from the storage server 103 and a manipulation example (No. 3) of the user. A confirmation screen for confirming the selected program genre is displayed on the browser 190 illustrated in FIG. 10. The confirmation screen is displayed when the user selects the image quality data relative to the program genres, “Sports (Baseball)”, “Movies (Action)”, and “Animation/Special Effects (Fight)” on the pull-down menu illustrated in FIG. 9 and pushes the NEXT button 190.

On a top of the display 170, a title M2, “Image Quality Data Input (through the Internet)” is displayed. Under the title M2, the browser 190 is displayed.

On a top of the browser 190, a name of equipment, “Name of Equipment: XXXX” is displayed. Under the name of equipment, a message, “Confirmation Screen for confirming the Selected Program Genre(s)” is also displayed. Under the message, the image quality data relative to the program genre, “Sports (Baseball)” selected in FIG. 9 is displayed. Under the message, items of the image quality data relative to the program genres, “Movies (Action)” and “Animation/Special Effects (Fight)” selected in FIG. 9 are also displayed. These program genres, “Movies (Action)” and “Animation/Special Effects (Fight)” selected in FIG. 9 are also selected similar to the program genre, “Sports (Baseball)” illustrated in FIG. 9. On a bottom of the browser 190, a CONFIRM button 194, a DELETE button 196, a RETURN button 198 are displayed.

The multiple items of the above-mentioned image quality data relative to the program genres, “Sports (Baseball)”, “Movies (Action)”, and “Animation/Special Effects (Fight)” can be selected by checking their check boxes. For example, the user pushes the selection buttons 182 of the remote controller 180 to set the mark 172 on the check box of “Sports (Baseball)” and pushes the decision button 184 to check this check box. Similarly, the user checks the check boxes of “Movies (Action)” and “Animation/Special Effects (Fight)”. Next, when the user sets the mark 172 on the CONFIRM button 194 and pushes the decision button 184, all of the items of the image quality data relative to the checked program genres, “Sports (Baseball)”, “Movies (Action)”, and “Animation/Special Effects (Fight)” can be selected.

If the user sets the mark 172 on the DELETE button 196 and pushes the decision button 184 when checking all of the check boxes of the image quality data relative to the above-mentioned three species of program genres, all of the items of the image quality data relative to the checked program genres can be deleted. If the user sets the mark 172 on the RETURN button 198 and pushes the decision button 184, the browser 190 illustrated in FIG. 9 is again displayed. Thus, the user can confirm or delete the image quality data relative to the selected program genres.

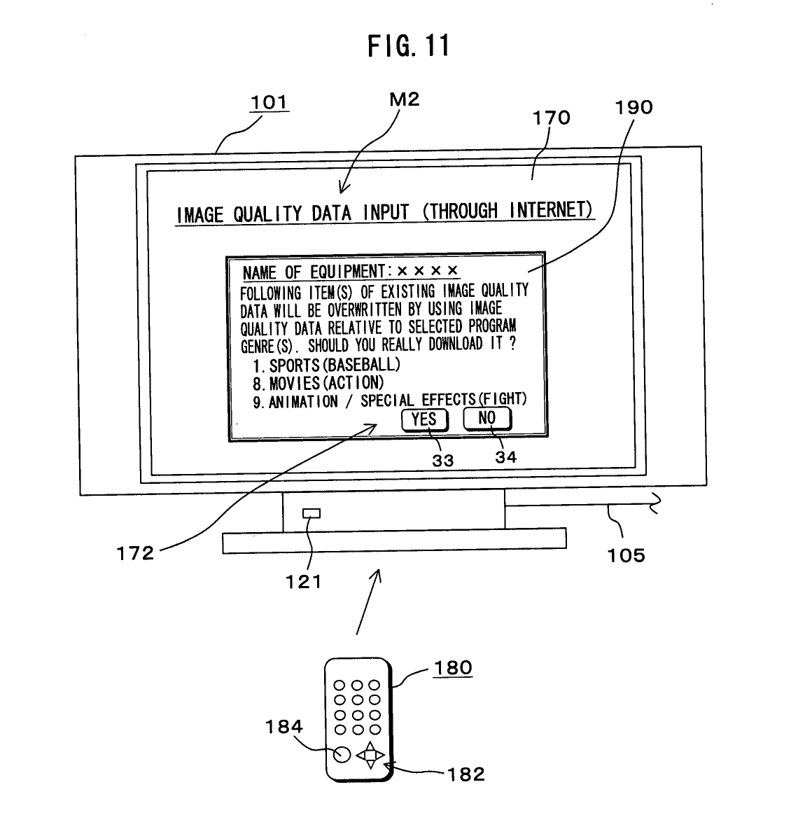

FIG. 11 illustrates a display example in the browser 190 when the image quality data is obtained from the storage server 103 and a manipulation example (No. 4) of the user. A confirmation screen for confirming the image quality data relative to three species of the selected program genres is displayed on the browser 190 illustrated in FIG. 11. The confirmation screen is displayed when the user checks all of the check boxes of “Sports (Baseball)”, “Movies (Action)”, “Animation/Special Effects (Fight)” illustrated in FIG. 10 and pushes the CONFIRM button 194.

On a top of the display 170, a title M2, “Image Quality Data Input (through the Internet)” is displayed. Under the title M2, the browser 190 is displayed.

On a top of the browser 190, a name of equipment, “Name of Equipment: XXXX” is displayed. Under the name of equipment, a verification message for verifying whether the image quality data selected in FIG. 10 is to be downloaded is also displayed. Under the verification message, the items of the image quality data relative to three species of program genres, “Sports (Baseball)”, “Movies (Action)”, and “Animation/Special Effects (Fight)” selected in FIG. 10 are displayed. This is because the user has checked all of the check boxes illustrated in FIG. 10 relating to these items of the image quality data. If the user checks only the check boxes of “Sports (Baseball)” and “Movies (Action)”, only the items of the image quality data relative to the program genres, “Sports (Baseball)” and “Movies (Action)” are displayed.

On a bottom of the browser 190, a YES button 200 and a NO button 202 are displayed. When the user verifies the image quality data displayed on the browser 190 illustrated in FIG. 11 and downloads the image quality data, he or she manipulates the selection buttons 182 to set the mark 172 on the YES button 200 and pushes the decision button 184. When the user does not download the image quality data, he or she manipulates the selection buttons 182 to set the mark 172 on the NO button 202 and pushes the decision button 184. After pushing the NO button 202, the user returns the display 170 illustrated in FIG. 10 where he or she again selects the image quality data. This prevents undesirable image quality data from being obtained.

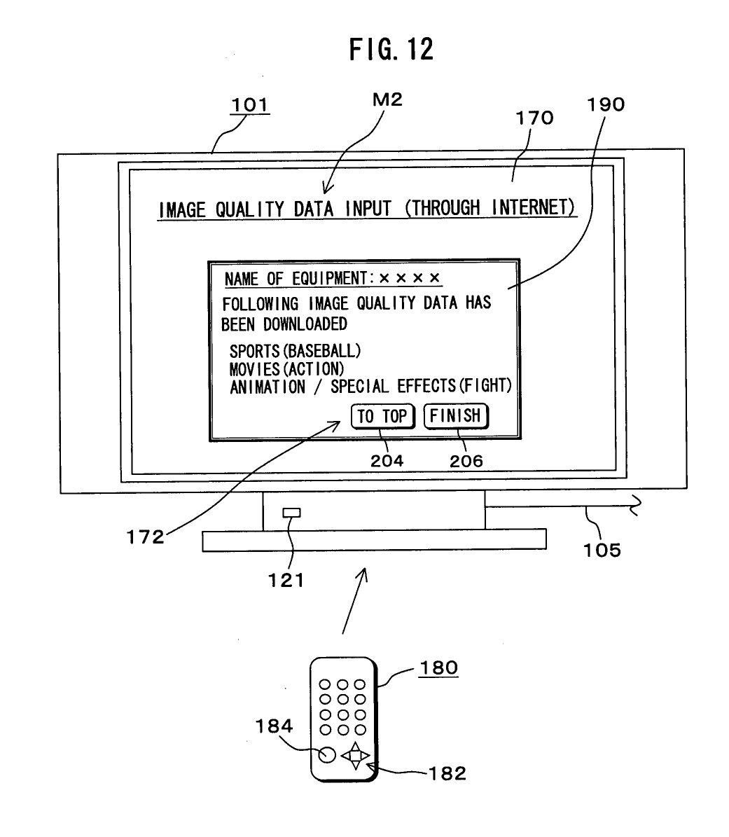

FIG. 12 illustrates a display example in the browser 190 when the image quality data is obtained from the storage server 103 and a manipulation example (No. 5) of the user. A confirmation screen for confirming that the image quality data has been downloaded is displayed on the browser 190 illustrated in FIG. 12. The confirmation screen is displayed when the user pushes the YES button 200 displayed in FIG. 11.

On a top of the display 170, a title M2, “Image Quality Data Input (through the Internet)” is displayed. Under the title M2, the browser 190 is displayed.

On a top of the browser 190, a name of equipment, “Name of Equipment: XXXX” is displayed. Under the name of equipment, a message that the image quality data verified in FIG. 11 has been downloaded is also displayed. Under this message, the items of the image quality data relative to three species of program genres, “Sports (Baseball)”, “Movies (Action)”, and “Animation/Special Effects (Fight)” verified in FIG. 11 are displayed. This enables the user to certify timing of completion of the download of the image quality data and any final results of the downloaded image quality data. Thus, downloading the image quality data set by another person through the Internet 107 allows any existing image quality data to be easily updated by using any previously adjusted image quality data. A maker side can distribute any image quality data set by a famous critic or the like through the Internet 107 so that new sales promotion can be carried out, thereby providing any utility to the maker. Any discussion between or among the customers relative to image quality can be realized on the Internet 107 so that the discussion can be further stimulated. This causes word-of-mouth advertising between or among the customers, thereby providing any utility to the maker.

On a bottom of the browser 190, a TO TOP button 204 and a FINISH button 206 are displayed. When the user sets the mark 172 on the TO TOP button 204 and pushes the decision button 184, the display 170 is returned to the selection screen for selecting input and/or input of the image quality data, which is illustrated in FIG. 7. When the user sets the mark 172 on the FINISH button 206 and pushes the decision button 184, the main CPU 117 closes the browser 190 to disconnect the connection with the storage server 103. It is to be noted that the browser 190 attaches a close button, not shown, and by clicking the close button, the browser 190 can finish anytime.

The following will describe an operation example of the image-displaying system 100 in which DTV1 101 acquires the image quality data from the storage server 103 through the Internet 107 to set the image quality data as image information.

[Storage Server]

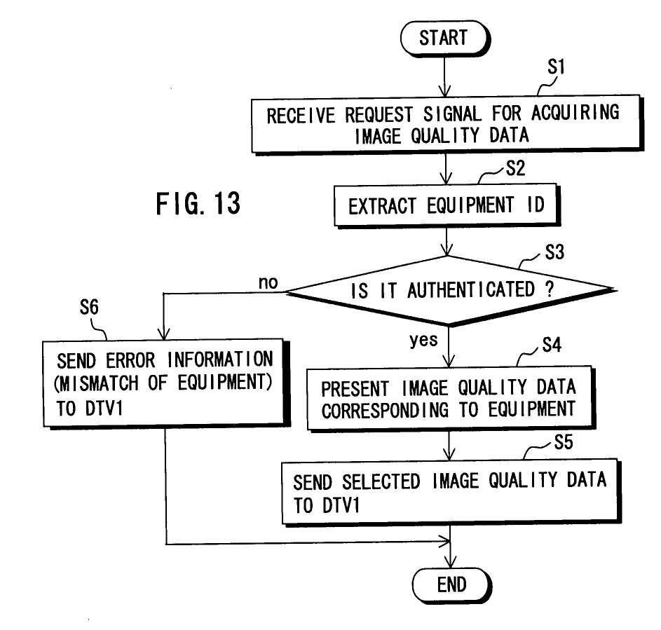

FIG. 13 is a flowchart for showing operations of the storage server 103. The storage server 103 is connected with the Internet 107 via the communication lines 105. The storage server 103 previously stores the image quality data set by a famous critic or the like.

At step S1, under these conditions of sending the image quality data, the storage server 103 receives a request signal for acquiring the image quality data from DTV1 101. The process then goes to step S2 where the storage server 103 extracts equipment identifier of the corresponding DTV1 101 from the received request signal for acquiring the image quality data.

The process then goes to step S3 where the storage server 103 authenticates the extracted equipment identifier. For example, the extracted equipment identifier of DTV1 101 is compared with plural equipment identifiers stored in the storage server 103. It is then determined whether or not the extracted equipment identifier of DTV1 101 matches any equipment identifiers stored in the storage server 103. If the extracted equipment identifier of DTV1 101 matches any equipment identifiers stored in the storage server 103, the process goes to step S4. If the extracted equipment identifier of DTV1 101 does not match any equipment identifiers stored in the storage server 103, the process goes to step S6.

At the step S4, the storage server 103 presents the image quality data corresponding to the equipment, DTV1 101. For example, the storage server 103 presents the image quality data relative to the program genre, “Sports (Baseball)” or the like illustrated FIGS. 8 and 9. The process then goes to step S5.

At the step S5, the storage server 103 sends the selected image quality data to the DTV1 101. For example, if the user selects the image quality data relative to the program genre, “Sports (Baseball)”, which has been presented at the step S4, the storage server 103 sends the image quality data relative to the program genre, “Sports (Baseball)” to DTV1 101 and the process of sending the image quality data finishes.

If the extracted equipment identifier of DTV1 101 does not match any equipment identifiers stored in the storage server 103 at the step S3, the storage server 103 sends any error information to DTV1 101 at the step S6. For example, an error message such that there is no image quality data corresponding to the equipment having the name of equipment: XXXX is sent to DTV1 101 and the process of sending the image quality data finishes.

Thus, the storage server 103 sends the image quality data stored therein to DTV1 101 in response to the request from DTV1 101.

[DTV1]

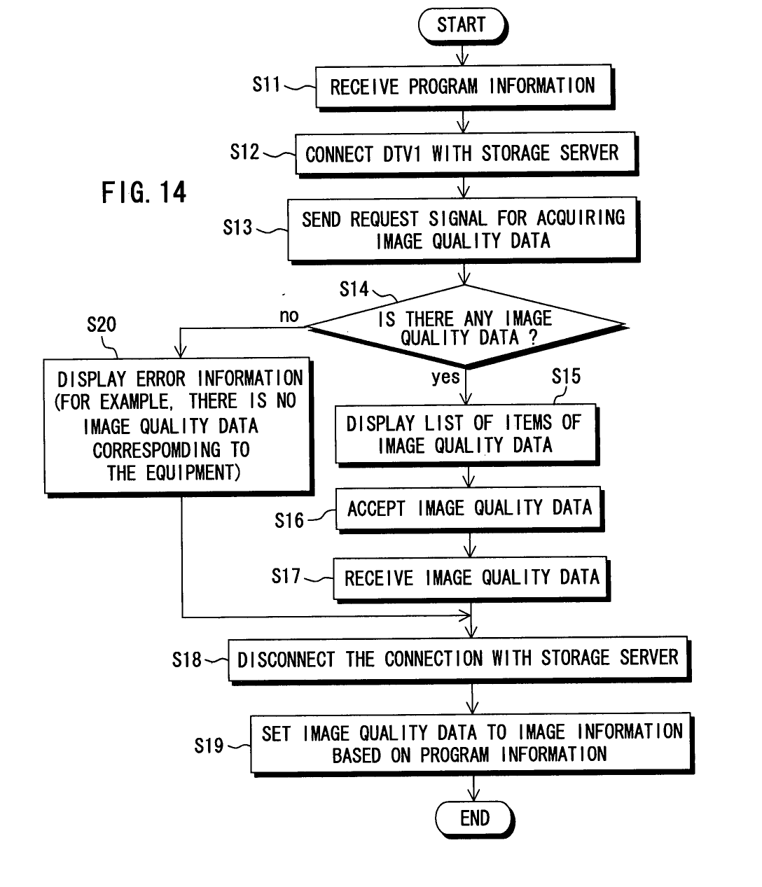

FIG. 14 is a flowchart for showing operations of DTV1 101. In this embodiment, the user connects DTV1 101 with the Internet 107 via the communication lines 105. At step S11 shown in FIG. 14, under this condition of adjusting the image quality, DTV1 101 receives program information based on the user's manipulation for acquiring the information. For example, a broadcast station broadcasts SI table information at a set period of time that is set by the user and DTV1 101 receives the SI table information through the UHF antenna 119 thereof. The received SI table information is transmitted to the main CPU 117 through the tuner 111, the digital-broadcast-receiving section 113, and the PCI bus 135. The main CPU 117 controls NVRAM 137 to store the SI table information therein through the sub CPU 133 and to produce EPG based on the SI table information and to store it therein. In EPG, channel information and the program genre information for each period of broadcast time are linked to each other. The process then goes to step S12 or later where DTV1 101 acquires the image quality data. It is to be noted that steps S12 through S19 relate to any processing for acquiring the image quality data.

At the step S12, DTV1 101 is connected with the storage server 103. For example, the user manipulates the selection buttons 182 of the remote controller 180 upward, downward, rightward, and leftward to set the mark 172 on an item of the Internet of the image quality data input of the display 170 illustrated in FIG. 7 and then, pushes the decision button 184. In this moment, an infrared-rays-receiving section, not shown, receives infrared rays from the remote controller 180 and transmits a decision signal to the main CPU 117. The main CPU 117 receives this determination signal and controls a hard disk, not shown, to read URL stored in the hard disk so that the DTV1 101 can be connected with the storage server 103 corresponding to the URL via the network terminal 125 and the communication lines 105. The process then goes to step S13.

At the step S13, DTV1 101 sends the request signal for acquiring the image quality data. For example, the main CPU 117 allows the request signal for acquiring the image quality data, which includes information on the equipment identifier of DTV1 101, to be sent to the storage server 103. The process goes to step S14.

At the step S14, DTV1 101 determines whether or not there is any image quality data corresponding to the equipment identifier thereof. If there is any image quality data corresponding to the equipment identifier sent to the storage server 103, the process goes to step S15. If there is no image quality data corresponding to the equipment identifier sent to the storage server 103, the process goes to step S20.

At the step S15, DTV1 101 displays a list of items of the image quality data. For example, as illustrated in FIG. 8, the pull-down menu is displayed under the message, “Selection of Program Genre” in the browser 190 displayed in the display 170. When the user manipulates the selection buttons 182 of the remote controller 180 to set the mark 172 on any items of the pull-down menu (various kinds of genres) and then, pushes the decision button 184, the display 170 displays the list of names of the program genres in the browser 190 with the names of the program genres being pulled down. After displaying them, if a lower selection button 182 is pushed to select the program genre, “Sports” and the decision button 184 is pushed, the list of the items of the image quality data relative to the selected program genre, “Sports” as illustrated in FIG. 9 is displayed. The process then goes to step S16.

At the step S16, DTV1 101 accepts any desired image quality data. For example, as illustrated in FIG. 9, the list of the items of the image quality data relative to the selected program genre, “Sports” such as “Baseball”, “Soccer”, “Sumo”, “Tennis”, “Golf” and the like is displayed. The user then selects a radio button of “Baseball” from these items. Similarly, the user can selects radio buttons of “Movies (Action)” and/or “Animation/Special Effects (Fight)”. When the user pushes the NEXT button 192, the confirmation screen illustrated in FIG. 10 in which these items can be selected by checking the check boxes is displayed. If the user pushes the CONFIRM button 194 while check boxes of the items of the image quality data relative to three species of program genres, “Sports (Baseball)”, “Movies (Action)”, and “Animation/Special Effects (Fight)” are all checked, the display 170 is changed to display a verification screen as illustrated in FIG. 11 for verifying whether the image quality data is to be downloaded. The process then goes to step S17.

At the step S17, DTV1 101 receives the image quality data from the storage server 103 through the Internet 107. For example, if the user pushes the YES button 200 displayed on the browser 190 illustrated in FIG. 11, DTV1 101 receives from the storage server 103 the image quality data relative to the program genres, “Sports (Baseball)”, “Movies (Action)”, and “Animation/Special Effects (Fight)” via the Internet 107 and the communication lines 105. DTV1 101 then displays the confirmation screen for confirming that the image quality data has been downloaded, which is illustrated in FIG. 12. In this moment, the main CPU 117 controls NVRAM 137 to overwrite items of the existing image quality data by using these items of image quality data and store them therein. The main CPU 117 also changes items of the names of program genres in the image quality data selection table 144 illustrated in FIG. 5. For example, item, “Sports” is changed to item, “Sports (Baseball)”; item, “Movies” is changed to item, “Movies (Action)”; and item, “Animation/Special Effects” is changed to item, “Animation/Special Effects (Fight)”. The process then goes to step S18. It is to be noted that a dialog box to promote the user's selection whether or not only the increased item(s) over the existing items of the image quality data is (are) updated or added may be displayed. This enables only the increased item(s) of the image quality data to be changed without any change of the existing items of the image quality data that the user has adjusted.

At the step S18, DTV1 101 disconnects the connection with the storage server 103. For example, when the user pushes the FINISH button 206 illustrated in FIG. 12, the main CPU 117 allows DTV1 101 to disconnect the connection with the storage server 103. The process then goes to step S19.

At the step S19, DTV1 101 sets the image quality data as the image information based on the program information. For example, when the television channel is changed to 3rd channel, the main CPU 117 transmits a channel change signal (3ch) to the sub CPU 133. The sub CPU 133 receives the channel change signal (3ch) and refers to EPG stored in the NVRAM 137 so that the program genre information, for example, “Sports” corresponding to the channel information (3ch) can be acquired from the EPG and the sub CPU 133 allows the image quality data relative to the program genre, “Sports (Baseball)”, which has previously been downloaded from the storage server 103, to be transmitted to the image-processing section 109 based on the acquired program genre information, “Sports”. The image-processing section 109 receives the image quality data relative to the program genre, “Sports (Baseball)” and adjusts brightness, contrast, color depth and the like of the image information based on the image quality data relative to the program genre, “Sports (Baseball)”. The image-processing section 109 then transmits the adjusted image information to the image-outputting section 115. The process for adjusting image quality then finishes.

If there is no image quality data corresponding to the equipment identifier sent to the storage server 103 at the step S14, DTV1 101 displays any error information at step S20. For example, the main CPU 117 allows an error message such that there is no image quality data corresponding to the equipment having the name of equipment: XXXX to be received from the storage server 103 and controls the image-outputting section 115 to display the error message. The image-outputting section 115 displays the error message on the display 170 of DTV1 101. The process then goes to the step S18. This enables the image quality data relative to the program genre, “Sports (Baseball)” or the like to be downloaded from the storage server 103 and to be set in the image-processing section 109 based on the program genre information.

It is to be noted that the main CPU 117 can receive the request signal for changing the image quality data from the remote controller 180, change contents of the image quality data based on the received request signal, and upload the image quality data having the changed contents to the storage server 103 through the Internet 107. This enables another user to download the image quality data thus uploaded to the storage server 103. Another user who downloads the uploaded image quality data can adjust any image quality of an image for every program genre based on the downloaded image quality data.

Thus, due to the embodiment of the image-displaying system 100 according to the invention, when a user adjust any image quality of an image, DTV1 101 receives any image quality data relative to program genre information from the storage server 103, selects any desired image quality data based on the program genre information among items of the received image quality data, and performs any processing on the information on the image based on the selected image quality data. Further, due to the embodiment of the image-displaying apparatus (DTV1 101) and the image-displaying method according to the invention, the sub CPU 133 provided for setting the image quality data sets the image quality data that is received through the communication lines 105 connected with the Internet 107 in the image-processing section 109 based on the program genre information. This enables any user to enjoy an image that satisfies any user's taste for every program genre. It is also possible to update any existing image quality data easily by using any previously adjusted image quality data.

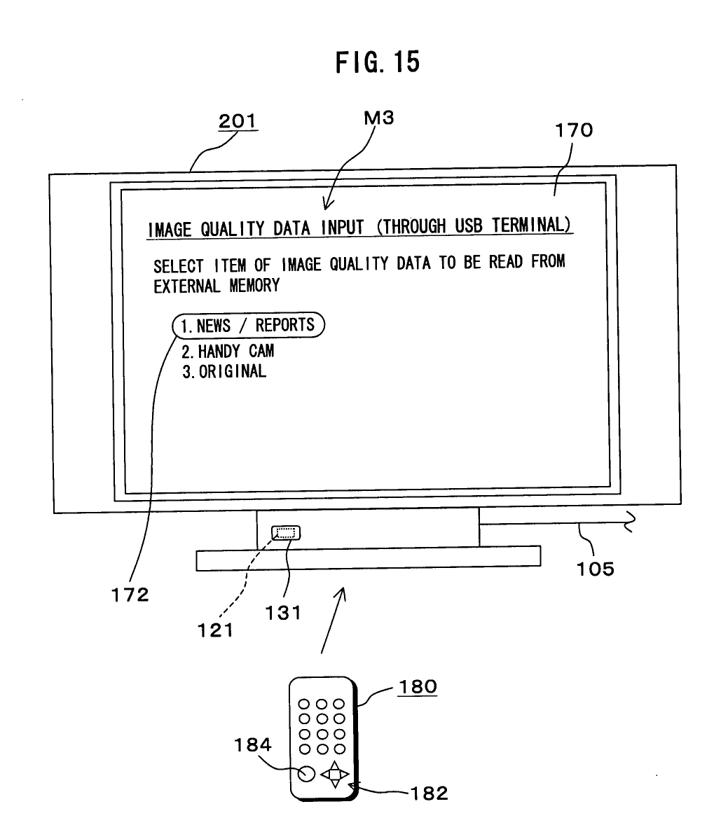

The following will describe other embodiments of an image-displaying system, an image-displaying apparatus, and an image-displaying method, in which the image quality data is inputted through the USB terminal 121. FIGS. 15 through 17 illustrate these embodiments of an image-displaying system, an image-displaying apparatus, and an image-displaying method, in which the image quality data is inputted through the USB terminal 121. Like reference characters that will be used in FIGS. 15 through 17 refer to like elements of the above embodiment shown in FIGS. 2 through 12, detailed description of which will be omitted.

FIG. 15 illustrates a display example in a display 170 of the DTV1 201 according to this embodiment when the image quality data is obtained from a USB memory 131 and a manipulation example (No. 1) of a user. The USB memory 131 is inserted into the USB terminal 121 of DTV1 201. A list screen of items of the image quality data stored in the inserted USB memory 131 is displayed on a display 170 of DTV1 201 as illustrated in FIG. 15. This list screen is displayed when a user sets the mark 172 on the item of USB of the image quality data input displayed on the display 170 illustrated in FIG. 7 and pushes the decision button 184 while the USB memory 131 is inserted into the USB terminal 121.

For example, when the user inserts the USB memory 131 into the USB terminal 121, the USB controller 123 controls the USB memory 131 to read a name of program genre of the image quality data out thereof through the USB terminal 121. Data relative to the read name of program genre is transmitted to the main CPU 117 through the PCI bus 135. The main CPU 117 controls the USB controller to output the data relative to the name of program genre thus read out through PCI bus 135. The main CPU 117 controls the sub CPU 133 to display the input data relative to the name of program genre.

On a top of the display 170 illustrated in FIG. 15, a title M3, “Image Quality Data Input (through the USB terminal)” is displayed. Under the title M3, the names of three species of the image quality data such as “News/Reports”, “Handy Cam” and “Original” stored in the USB memory 131 are displayed.

A user manipulates a lower selection button 182 of the remote controller 180 to set the mark 172 on the item of “News/Reports” and pushes the decision button 184. In this moment, the main CPU 117 controls the USB controller 123 to read the image quality data relative to “News/Reports” from the USB memory 131. The USB controller 123 controls the USB memory 131 to read the image quality data relative to “News/Reports” out thereof through the USB terminal 121. This enables the image quality data stored in the USB memory 131 to be acquired. It is to be noted that when the image quality data to be read out of the USB memory 131 is displayed and selected, any scheme by which one item of the image quality data can be selected such as a pull-down menu and a spinbox may be used in addition to the above list screen scheme.

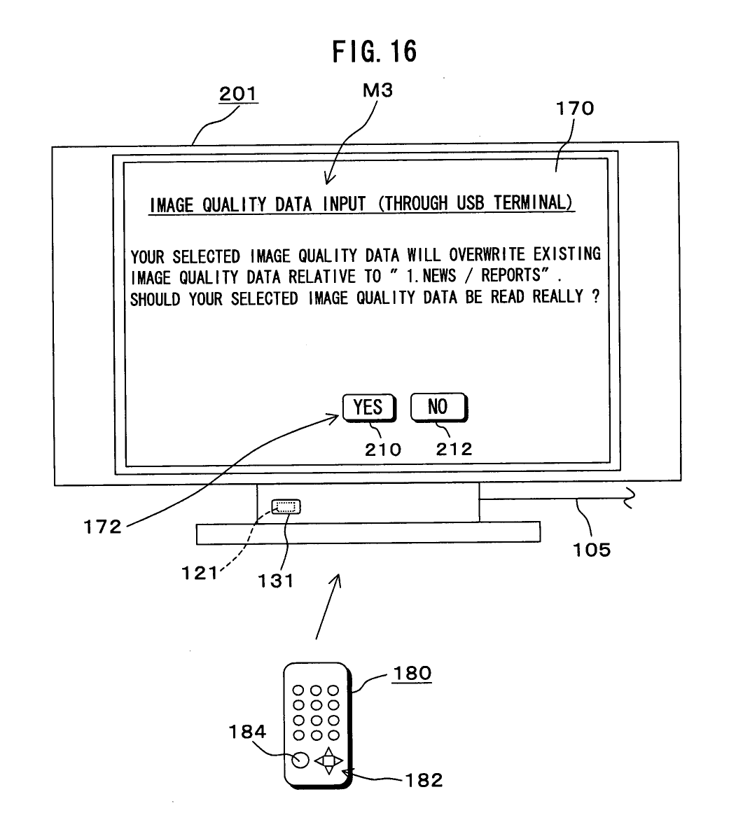

FIG. 16 illustrates a display example in the display 170 of the DTV1 201 according to this embodiment when the image quality data is obtained from the USB memory 131 and a manipulation example (No. 2) of the user. A confirmation comment of the selected image quality data is displayed on the display 170 illustrated in FIG. 16. The confirmation comment is displayed when the user selects the item of “News/Reports” illustrated in FIG. 15 and pushes the decision button 184.

On a top of the display 170, a title M3, “Image Quality Data Input (through the USB terminal)” is displayed. Under the title M3, the confirmation comment for confirming whether any image quality data relative to “News/reports” selected in FIG. 15 should overwrite the existing image quality data is displayed. On a bottom of the display 170, a YES button 210 and a NO button 212 are displayed.

When the user agrees with the confirmation comment, he or she manipulates the selection buttons 182 to set the mark 172 on the YES button 210 and pushes the decision button 184. The main CPU 117 then controls NVRAM 137 to overwrite the existing image quality data by using the acquired image quality data relative to “News/Reports” and store the overwritten image quality data. The main CPU 117 also controls the image-outputting section 115 to display a screen of the display 170 illustrated in FIG. 15 in order to promote his or her reselection of the image quality data.

When the user disagrees with the confirmation comment, he or she manipulates the selection buttons 182 to set the mark 172 on the NO button 212 and pushes the decision button 184. The main CPU 117 then controls the image-outputting section 115 to display a screen of the display 170 illustrated in FIG. 15 in order to promote his or her reselection of the image quality data without overwriting the existing image quality data by using the acquired image quality data relative to “News/Reports” and storing the overwritten image quality data. This prevents any undesirable image quality data from being acquired.

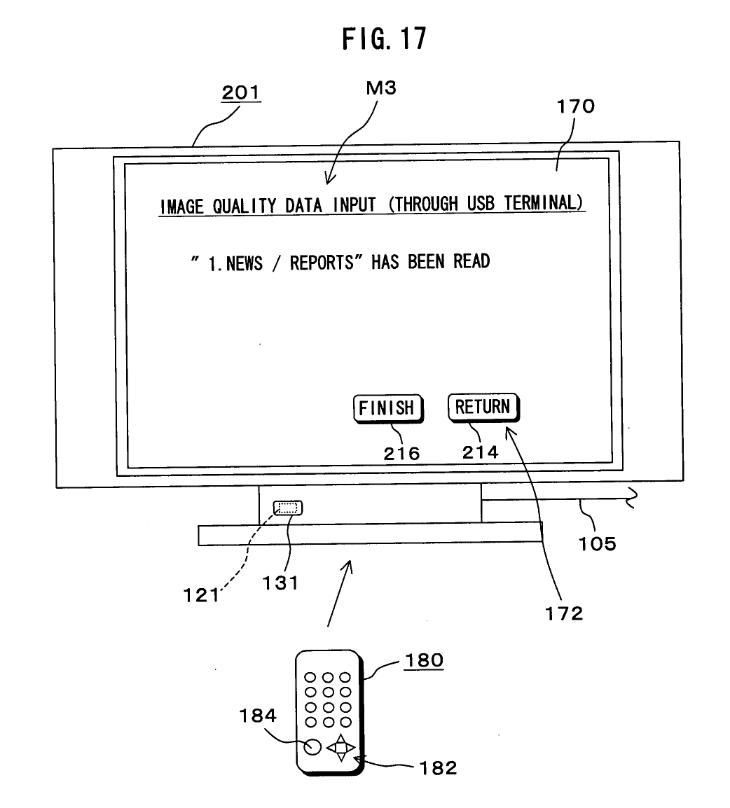

FIG. 17 illustrates a display example in the display 170 of the DTV1 201 according to this embodiment when the image quality data is obtained from the USB memory 131 and a manipulation example (No. 3) of the user. A screen for confirming that the image quality data has been read is displayed on the display 170 illustrated in FIG. 17. This screen is displayed when the user pushes the YES button 210 displayed in FIG. 16.

On a top of the display 170, a title M3, “Image Quality Data Input (through the USB terminal)” is displayed. Under the title M3, a comment for confirming that the image quality data relative to “News/reports” confirmed in FIG. 16 has overwritten the existing image quality data is displayed.

On a bottom of the display 170, a RETURN button 214 and a FINISH button 216 are displayed. If the user sets the mark 172 on the RETURN button 214 and pushes the decision button 184, the list screen for displaying items of the image quality data stored in the USB memory 131 as illustrated in FIG. 15 is displayed. Thus, the user can acquire items of image quality data relative to “Handy Cam” and “Original” similar to the acquirement of image quality data relative to “News/Reports”.

The sub CPU 133 controls the image-processing section 109 to receive the acquired image quality data relative to “News/Reports” and the like based on the program genre information. The image-processing section 109 receives the image quality data relative to “News/Reports” and the like and adjusts any information on the image on its brightness, contrast, color depth and the like based on the received image quality data relative to “News/Reports” and the like. The image-processing section 109 also transmits the adjusted information on the image to the image-outputting section 115. The image-outputting section 115 displays the image on the display 170 based on this information on the image.

If the user sets the mark 172 on the FINISH button 216 and pushes the decision button 184, the screen of image quality data input through the USB terminal 121 finishes, so that the image quality data input/output screen illustrated in FIG. 7 can be again displayed. Further, if the user takes the USB memory 131 out of the USB terminal 121, operations similar to the case where the user pushes the FINISH button 216 are performed.

Thus, due to this embodiment of the image-displaying apparatus DTV1 201 and the like according to the invention, when a user adjust any image quality of an image, the sub CPU 133 provided for setting the image quality data allows the image quality data that is received through the USB terminal 121 to be set based on the program genre information and any information on the image in the image-processing section 109 to be adjusted based on the set image quality data. This enables any user to enjoy an image that satisfies any user's taste for every program genre. It is also possible to update any existing image quality data easily by using any previously adjusted image quality data.

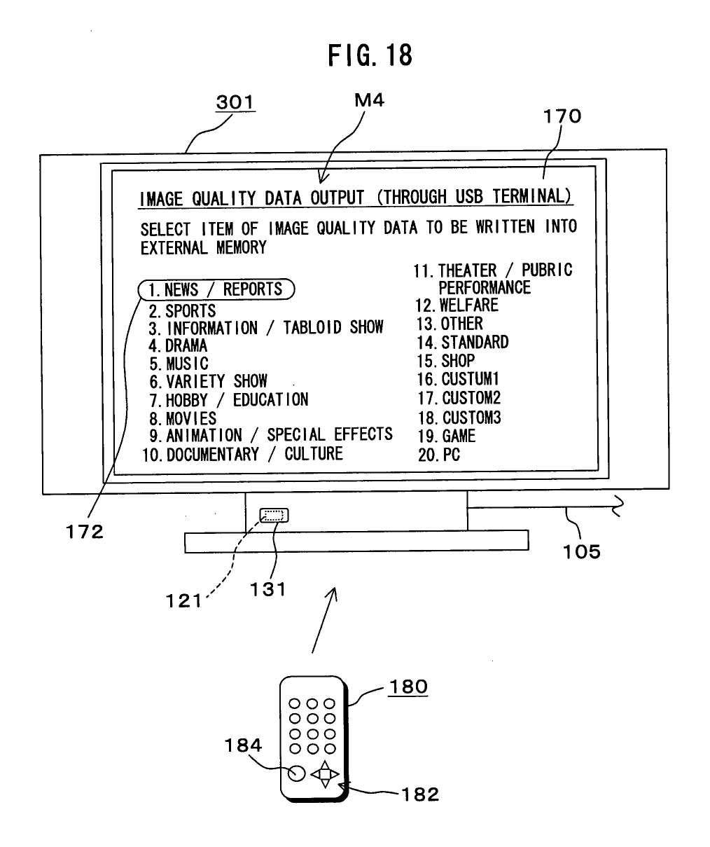

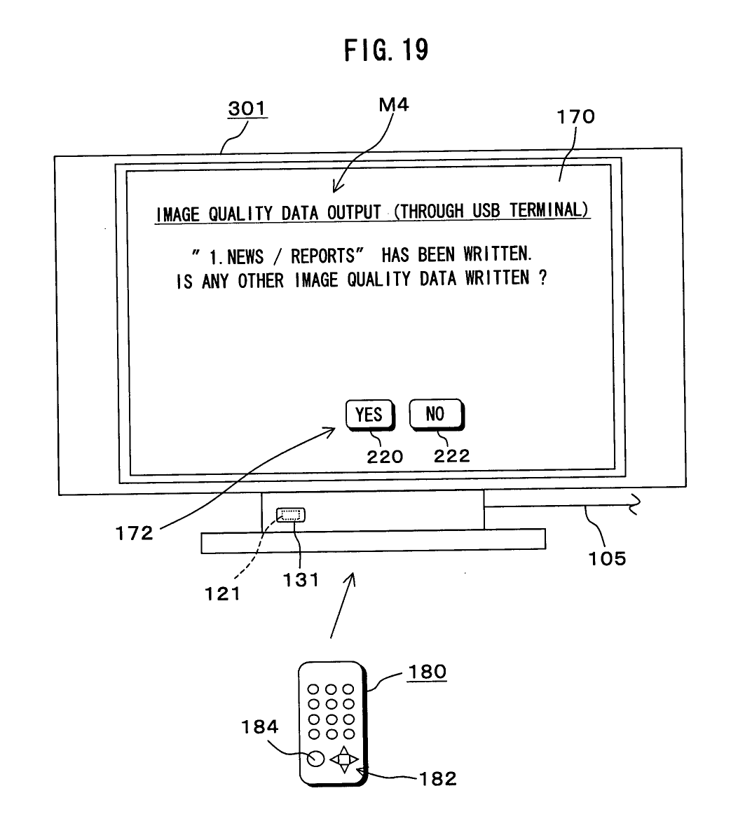

The following will describe further embodiments of an image-displaying system, an image-displaying apparatus, and an image-displaying method, in which the USB memory 131 can store the image quality data to allow another user to utilize the image quality data stored in the DTV1 301. FIGS. 18 and 19 illustrate these embodiments of an image-displaying system, an image-displaying apparatus, and an image-displaying method, in which the image quality data is outputted through the USB terminal 121. Like reference characters that will be used in FIGS. 18 and 19 refer to like elements of the above embodiment shown in FIGS. 2 through 12, detailed description of which will be omitted.

FIG. 18 illustrates a display example in a display 170 of the DTV1 301 when the image quality data is output to the USB memory 131 and a manipulation example (No. 1) of a user. The USB memory 131 is inserted into the USB terminal 121 of DTV1 301. A list screen of items of the image quality data to be written into the inserted USB memory 131 is displayed on a display 170 of DTV1 301 as illustrated in FIG. 18. This list screen is displayed when a user sets the mark 172 on the item of USB of the image quality data output displayed on the display 170 illustrated in FIG. 7 and pushes the decision button 184.

On a top of the display 170, a title M4, “Image Quality Data Output (through the USB terminal)” is displayed. Under the title M4, a comment that allows the user to select the item(s) of the image quality data to be written into the USB memory 131 is displayed. Under this comment, names of twenty species of image quality data illustrated in FIG. 3 are displayed.

For example, the user manipulates the selection buttons 182 of the remote controller 180 to set the mark 172 on the item of “News/Reports” and pushes the decision button 184. In this moment, the main CPU 117 controls the NVRAM 137 to read the image quality data relative to “News/Reports” stored therein and transmit it to the USB controller 123 through the PCI bus 135. The USB controller 123 controls the USB memory 131 to write the received image quality data relative to “News/Reports” therein through the USB terminal 121. This enables the image quality data relative to “News/Reports” to be delivered to another user.

It is to be noted that when the image quality data to be written into the USB memory 131 is displayed and selected, any scheme by which one item of the image quality data can be selected such as a pull-down menu and a spinbox may be used in addition to the above list screen scheme.

FIG. 19 illustrates a display example in the display 170 of the DTV1 301 when the image quality data is output to the USB memory 131 and a manipulation example (No. 2) of the user. A confirmation screen for confirming whether or not any other image quality data is written is displayed on the display 170 illustrated in FIG. 19. The confirmation screen is displayed when the user sets the mark 172 on the item of “News/Reports” illustrated in FIG. 18 and pushes the decision button 184.

On a top of the display 170, the title M4, “Image Quality Data Output (through the USB terminal)” is displayed. Under the title M4, a comment that the image quality data relative to “News/reports” has been written is displayed. Another comment for confirming whether or not any other image quality data is written is also displayed. On a bottom of the display 170, a YES button 220 and a NO button 222 are displayed.

When the user desires to write any other image quality data, he or she manipulates the selection buttons 182 to set the mark 172 on the YES button 220 and pushes the decision button 184. The display 170 then changes its screen to the list screen of items of the image quality data illustrated in FIG. 18.

When the user does not write any other image quality data, he or she manipulates the selection buttons 182 to set the mark 172 on the NO button 222 and pushes the decision button 184. The display 170 returns to the image quality data input/output screen illustrated in FIG. 7 in which the user can select the input and/or input of the image quality data.

Thus, due to this embodiment of the image-displaying apparatus DTV1 301 and the like according to the invention, when a user stores any image quality data in an external memory, the main CPU 117 controls NVRAM 137 to read the image quality data stored therein and write the read image quality data into the USB memory 131 through the USB terminal 121, based on the user's manipulation of the remote controller 180.

This enables any image quality data for adjustment to be stored in the external memory without taking a lot of time and allows another user to use the image quality data stored in the external memory as the image quality data for his or her own DTV1 or the like. It is thus possible to adjust image quality of an image for every program genre based on the input image quality data.

The following will describe an example of writing the image quality data to a text file and an example of checking the text file.

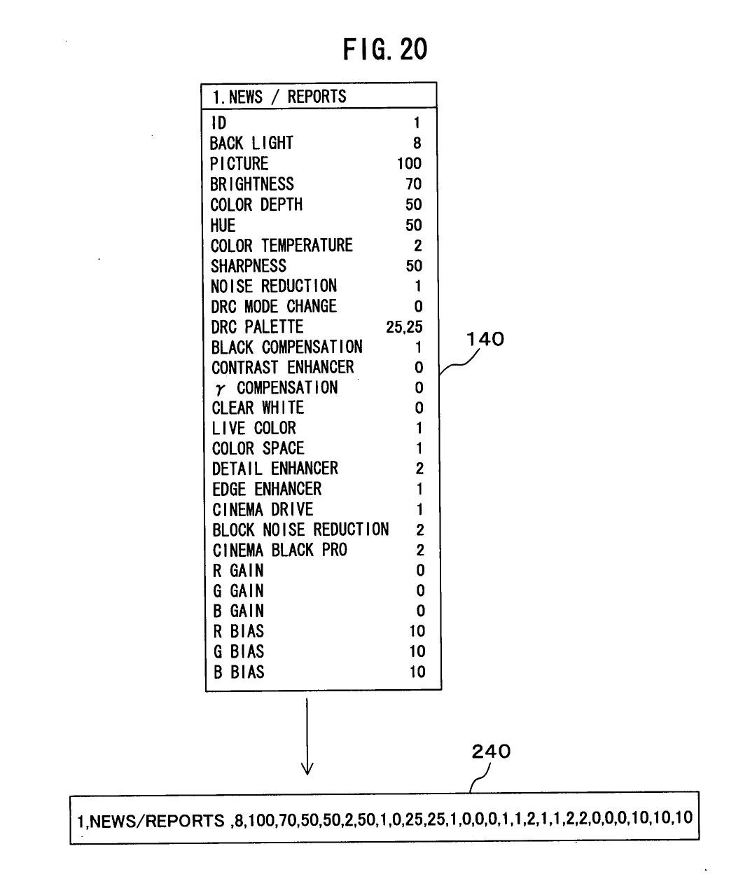

FIG. 20 illustrates an example of writing the image quality data 140 to the text file 240. In FIG. 20, the image quality data 140 relative to the program genre, “News/Reports” is written to the text file 240.

As the text file 240, “/DTV/X1000/PictureData/”, for example, is set as a folder of write address or read address in the USB memory 131. It can be set as any folder if the write address and the read address are matched to each other. A user can set a folder of write address or read address optionally. The text file 240 is stored automatically as “ID+name of the image quality data.txt” such as “1_News/Reports.txt”. The user can change the name of the image quality data. For example, the name of the image quality data, “1_News/Reports” can be changed to “1_News”. If reading the changed name of the image quality data, “1_News”, the item of the name of program genre, “News/Reports” in the image quality data selection table 144 illustrated in FIG. 5 is changed to “News”. This enables the item of the name of program genre, “1. News/Reports” to be changed to “1. News” when displaying the list of items of the names of program genres on the display 170 illustrated in FIG. 18. Thus, it is possible to realize easily how much image quality the set image quality data has, thereby allows the user to select any suitable image quality data easily.

As an example of a format when the image quality data 140 is written to the text file 240, as illustrated in FIG. 20, a description scheme for punctuating the data by commas in turn such as “ID”, “Names of Image Quality Data”, “Backlight value”, “Picture value”, . . . , and “B bias value” is illustrated.

As reading method, a reading scheme such that one text file is converted to one item of the image quality data and such the image quality data is then read is conceivable. For example, the user inserts the USB memory 131 that stores the text file 240 into the USB terminal 121. After the insertion, the USB controller 123 controls the USB memory 131 to retrieve the text file 240 and read the image quality data 140 out thereof. The USB controller 123 then transmits the read image quality data 140 to the main CPU 117 through PCI bus 135. The main CPU 117 controls the NVRAM 137 to receive and store the image quality data 140 as the image quality data relative to program genre, “News/Reports” as illustrated in FIG. 3. It is to be noted that when reading or writing the image quality data from or into the USB memory 131, a binary file, an encrypted text file, and an encrypted binary file may be used in addition to the text file.

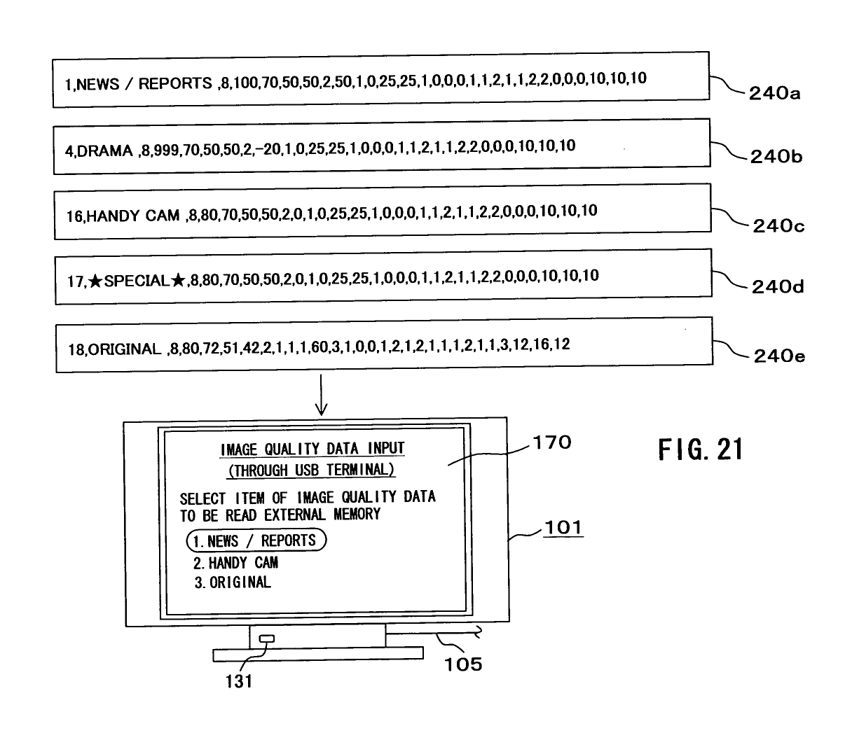

FIG. 21 illustrates an example of reading the text files 240a through 240e. These text files 240a through 240e illustrated in FIG. 21 are stored in, for example, the USB memory 131. When the USB memory 131 is inserted into the USB terminal 121, the USB controller 123 controls the USB memory 131 to read the data out thereof through the USB terminal 121. The USB controller 123 then transmits the read data to the main CPU 117 through the PCI bus 135. The main CPU 117 checks numbers of items of the input image quality data, letters that are used in the names of image quality data, an accepted extent of each of the image quality data values, and the like.

The text file 240b contains any unaccepted data such as “999” and “−20” out of the accepted extent of each of the image quality data values. The text file 240d also contains any unaccepted letters such as “★” that is forbidden from being used therein. In this case, the main CPU 117 avoids displaying the text files 240b, 240d on the display 170 that have been checked as a text file containing unaccepted data. This prevents the image quality data from overwriting any existing image quality data by using the erroneous image quality data, contents of which a user changes by using a personal computer to change the image quality data in the text files 240 in error.

It is preferable to confirm whether or not the data is to be overwritten by using a dialog box or the like because the image quality data having the same identifier as that of the image quality data stored in the NVRAM 137, which is read out of the USB memory 131, overwrites the image quality data stored in the NVRAM 137. A user interface (UI) such that the name of image quality data can be changed with freedom by using a software keyboard, not shown, built in DTV1 301 may be prepared. It is also preferable to confirm whether or not any letters that the main CPU 117 prohibits from being used are contained in the names of the image quality data since any DTV1 has a limitation on fonts.

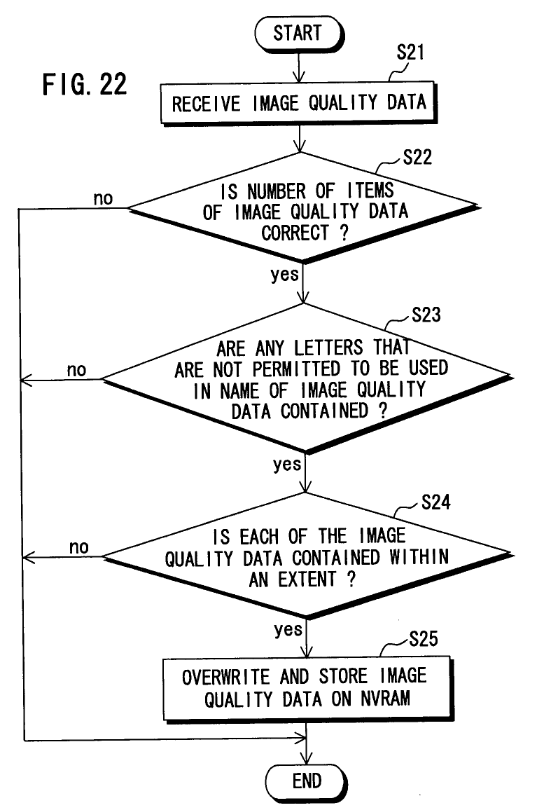

FIG. 22 is a flowchart for showing a check example of the text files. At step S21 shown in FIG. 22, DTV1 receives the image quality data. For example, when the USB memory 131 is inserted into the USB terminal 121, the USB controller 123 controls the USB memory 131 to read the data out thereof through the USB terminal 121 and transmits the read image quality data to the main CPU 117 through the PCI bus 135. The main CPU 117 receives the image quality data from the USB controller 123 and the process goes to step S22.

At the step S22, DTV1 determines whether or not number of the items of image quality data is correct. For example, normal number of the items of image quality data is stored in the NVRAM 137 so that the main CPU 117 reads the normal number of the items of image quality data therefrom to compare the number of items of the received image quality data with the read normal number of the items of image quality data. If the number of items of the received image quality data agrees with the read normal number of the items of image quality data, the process goes to step S23. If the number of items of the received image quality data disagrees with the read normal number of the items of image quality data, the process finishes.

At the step S23, DTV1 determines whether or not letter(s) that are not permitted to be used in the name of image quality data is (are) contained. For example, all the letters that are permitted to be used in the names of image quality data are stored in the NVRAM 137 so that the main CPU 117 controls the NVRAM 137 to read the letters that are permitted to be used in the names of image quality data to compare letters contained in the received image quality data with the read letters that are permitted to be used in the names of image quality data. If all the letters contained in the received image quality data are the letters that are permitted to be used in the names of image quality data, the process goes to step S24. If any letters other than the letters that are permitted to be used in the names of image quality data are contained in the received image quality data, the process finishes.

At the step S24, DTV1 determines whether or not each of the items of the image quality data is contained within an accepted extent. For example, normal extent of each of the items of the image quality data is stored in the NVRAM 137 so that the main CPU 117 controls the NVRAM 137 to read the normal extent to compare each of the values of the received image quality data with the read normal extent. If all the values of the received image quality data stay in its normal extent, the process goes to step S25. If any values of the received image quality data stay out of its normal extent, the process finishes.

At the step S25, DTV1 overwrites the existing image quality data in the NVRAM 137 by using the selected image quality data and stores the overwritten one. For example, the main CPU 117 transmits the checked image quality data to the sub CPU 133 and the sub CPU 133 controls the NVRAM 137 to overwrite the existing image quality data in the NVRAM 137 by using the checked image quality data and store the overwritten one. Of course, the image quality data received through the communication lines 105 may be checked by similar processing.

Thus, due to this embodiment of the image-displaying apparatus DTV1 and the like according to the invention, when receiving any image quality data through the USB terminal 121, the communication lines 105, and the like, the main CPU 117 is used to check the numbers of items of the input image quality data, letters that are used in each of the names of image quality data, an accepted extent of each of the image quality data values, and the like.

This prevents any error image quality data from overwriting the existing image quality data in the NVRAM 137 even if the image quality data in the text files 240, contents of which the user change in error by using the personal computer or the like, is stored in the USB memory 131.

It is to be noted that the embodiments of an image-displaying system, an image-displaying apparatus, and an image-displaying method according to the invention may have a sound-quality-sommelier function in addition to the image-quality-sommelier function. Any modifications may be applied to DTV1 to which an existing external recording medium can be connected, by only alteration of software, so that such the modifications in the embodiments of an image-displaying system, an image-displaying apparatus, and an image-displaying method according to the invention may be easily realized without increasing any hardware costs.

If the image quality data is received by electric wave, an electric wave sending apparatus sends electric wave including the image quality data to DTV1 and DTV1 then receives the electric wave including the image quality data to select the image quality data based on the program genre information among the items of the received image quality data. The DTV1 then performs any processing on information on an image based on the selected image quality data.

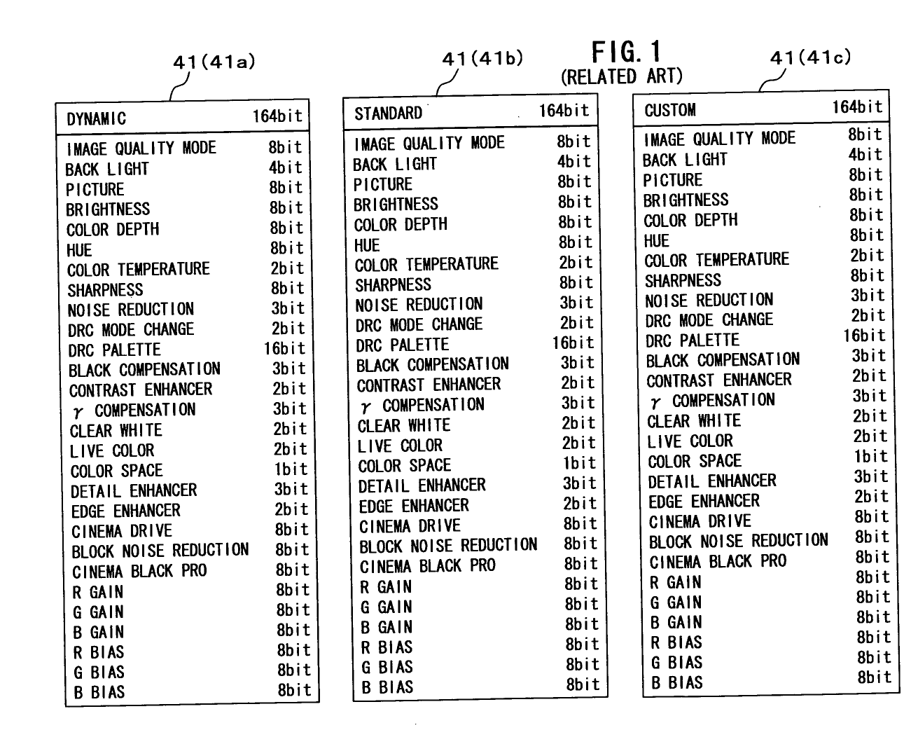

The following will describe a volume of image quality data to be stored in the NVRAM 137 relative to the above embodiments. When comparing the image quality data shown in FIG. 1 as related art with the image quality data shown in FIG. 2, it is obvious that there are items of image quality modes in the image quality data shown in FIG. 1 as related art but there is no item of ID in the image quality data.

For example, if input numbers are fifteen, the NVRAM 137 has a total volume of 900 bytes (=3 (image quality set modes of the image quality data)*15 (input numbers)*20 bytes) in related art shown in FIG. 1. In these above-mentioned embodiments, however, items of the image quality data are exclusively managed by using the image quality data selection table 144 illustrated in FIG. 5 so that the NVRAM 137 may store only a volume of 20 bytes for every one item of the image quality data and which image quality mode the user views and hears the image quality data for each input. Two bytes are sufficient for each input to determine which image quality mode. If the species of the image quality data are 20 and input numbers are fifteen, the NVRAM 137 in each of these embodiments has a total volume of about 430 bytes (=20 (image quality modes)*20 bytes+15 (input numbers)*2 bytes). In this moment, each time the program genres are changed, the image quality data automatically switched alters, so that the NVRAM 137 does not store it. Thus, even if items of the image quality data that can be selected for each genre of input are considerably increased, the NVRAM 137 for storing image quality set values and managing items of the image quality data exclusively by using the image quality data selection table 144 may have a moderate volume, not considerable increased one.

The invention is preferably applied to an image-displaying system, an image-displaying apparatus, and an image-displaying method, in which image quality of the displayed image can be adjusted.

It should be understood by those skilled in the art that various modifications, combinations, sub-combinations and alternations may occur depending on design requirements and other factors insofar as they are within the scope of the appended claims or the equivalents thereof.

What is claimed is:

1. An image-displaying apparatus comprising:
receiving means for receiving at least program information indicating a genre of an image and information on the image;
image-processing means for performing processing relative to image quality of the information on the image received by the receiving means;
input-controlling means for controlling input of image quality information for adjusting image quality of the image through a transmission medium based on the program information received by the receiving means; and
image-quality-setting means for setting the image quality processed in the image-processing means by using the image quality information input by the input-controlling means.

2. The image-displaying apparatus according to claim 1 further comprising a storage means for storing the image quality information.

3. The image-displaying apparatus according to claim 1 wherein the transmission medium contains a communication line, electromagnetic wave, and an information transmission channel.

4. The image-displaying apparatus according to claim 1 wherein the input-controlling means controls receipt of a request signal for changing the image quality information, change of the image quality information based on the received request signal, and output of the changed image quality information through the transmission medium.

5. The image-displaying apparatus according to claim 1 wherein when inputting the image quality information through the transmission medium, the input-controlling means verifies at least number of items of data on the input image quality information, character used for a name of the image quality information, and an extent of values in each item of data on the image quality information.

6. An image-displaying apparatus comprising:
receiving device that receives at least program information indicating a genre of an image and information on the image;
image-processing device that performs processing relative to image quality of the information on the image received by the receiving device;
input-controlling device that controls input of image quality information for adjusting image quality of the image through a transmission medium based on the program information received by the receiving device; and
image-quality-setting device that sets the image quality processed in the image-processing device by using the image quality information input by the input-controlling device.

7. An image-displaying method comprising the steps of:
receiving at least program information indicating a genre of an image;
inputting image quality information for adjusting image quality of the image through a transmission medium based on the received program information;
selecting the image quality information from the input image quality information based on the program information; and
performing processing relative to image quality of the information on the image based on the selected image quality information.

8. The image-displaying method according to claim 7 wherein the transmission medium contains a communication line, electromagnetic wave, and an information transmission channel.

9. The image-displaying method according to claim 7 further comprising the steps of:
changing the image quality information; and
outputting the changed image quality information through the transmission medium.

10. An image-displaying apparatus comprising:
a set number of terminals that receives information on an image;
image-processing means for performing processing relative to image quality of the information on the image received through the terminals;
input-controlling means for controlling input of image quality information for adjusting image quality of the image through a transmission medium, relative to the information on the image; and
image-quality-setting means for setting the image quality processed in the image-processing means by using the image quality information input by the input-controlling means,
wherein the image-quality-setting means receives a image-switching signal; and
wherein the image quality is set in the image-processing means based on the input image-switching signal.

11. An image-displaying apparatus comprising:
a set number of terminals that receives information on an image;
image-processing device that performs processing relative to image quality of the information on the image received through the terminals;
input-controlling device that controls input of image quality information for adjusting image quality of the image through a transmission medium, relative to the information on the image; and
image-quality-setting device that sets the image quality processed in the image-processing device by using the image quality information input by the input-controlling device,
wherein the image-quality-setting device receives a image-switching signal; and
wherein the image quality is set in the image-processing device based on the input image-switching signal.

12. An image-displaying method comprising the steps of:
inputting image quality information for adjusting image quality of an image through a transmission medium;
inputting an image-switching signal for switching input of the image after inputting the image quality information;
selecting the image quality information based on the input image-switching signal; and
performing processing relative to image quality of the information on the image based on the selected image quality information.

13. An image-displaying system comprising:
a sending apparatus that sends image quality information for adjusting image quality of an image in reply to a request; and
an image-displaying apparatus that displays the image based on the image quality information received from the sending apparatus,
wherein the image-displaying apparatus includes:
receiving device that receives at least program information indicating a genre of an image and information on the image;
image-processing device that performs processing relative to image quality of the information on the image received by the receiving device;
input-controlling device that controls input of image quality information for adjusting image quality of the image through a transmission medium based on the program information received by the receiving device; and
image-quality-setting device that sets the image quality processed in the image-processing device by using the image quality information input by the input-controlling device.

14. An image-displaying system comprising:
a sending apparatus that sends image quality information for adjusting image quality of an image in reply to a request; and
an image-displaying apparatus that displays the image based on the image quality information received from the sending apparatus,
wherein the image-displaying apparatus includes:
a set number of terminals that is connected to an image-outputting device and receives information on an image from the image-outputting device;
image-processing device that performs processing relative to image quality of the information of the image received through the terminals;
input-controlling device that controls input of image quality information for adjusting image quality of the image through a transmission medium, relative to the information on the image received from the image-outputting device; and
image-quality-setting device that sets the image quality processed in the image-processing device by using the image quality information input by the input-controlling device,
wherein the image-quality-setting device receives a image-switching signal when the image-outputting device that outputs the information on the image is switched; and
wherein the image quality is set in the image-processing device based on the input image-switching signal.
